(19) United States
(12) Patent Application Publication
(10) Pub. No.: US 2025/0310820 A1
(43) Pub. Date: Oct. 2, 2025

(54) DELAY SERVICES FOR MULTI-MODALITY

(71) Applicant: Apple Inc., Cupertino, CA (US)

(72) Inventors: Ping-Heng Kuo, London (GB); Zhibin Wu, Los Altos, CA (US); Naveen Kumar R. Palle Venkata, San Diego, CA (US); Peng Cheng, Beijing (CN); Fangli Xu, Beijing (CN); Yuqin Chen, Beijing (CN); Ralf Rossbach, Munich (DE); Haijing Hu, Los Gatos, CA (US); Alexander Sirotkin, Tel Aviv (IL)

(73) Assignee: Apple Inc., Cupertino, CA (US)

(21) Appl. No.: 19/067,672

(22) Filed: Feb. 28, 2025

Related U.S. Application Data
(60) Provisional application No. 63/572,748, filed on Apr. 1, 2024.

(51) Int. Cl. H04W 28/02; H04W 80/02

(52) U.S. Cl. CPC H04W 28/0236; H04W 28/0268; H04W 80/02

(57) ABSTRACT

The present application relates to devices and components including apparatus, systems, and methods related to delay status reporting in wireless communication systems.

### CROSS-REFERENCE TO RELATED APPLICATION

This application claims priority to U.S. provisional application No. 63/572,748, entitled “Delay Services for Multi-Modality,” filed on Apr. 1, 2024, the disclosure of which is incorporated by reference herein in its entirety for all purposes.

### TECHNICAL FIELD

The present application relates to the field of wireless technologies and, in particular, to delay services for multi-modality operation.

### BACKGROUND

Third Generation Partnership Project (3GPP) networks utilize multiple different channels for communicating data. The devices implement buffers for the different channels, where the buffers are utilized for storing data while waiting for resources to become available for communicating the data via the channels. When data is added to a buffer, countdown of a corresponding discard timer is initiated and the data is discarded from the buffer at expiry of the discard timer. The data is to be transmitted via the channel prior to expiry of the discard timer and prior to discarding of the data from the buffer.

### BRIEF DESCRIPTION OF THE DRAWINGS

FIG. 1 illustrates a network environment in accordance with some embodiments.

FIG. 2 illustrates a user equipment (UE) in accordance with some embodiments.

FIG. 3 illustrates a network device in accordance with some embodiments.

FIG. 4 illustrates an example buffered data delay reporting and discard arrangement in accordance with some embodiments.

FIG. 5 illustrates an example delay status reporting (DSR) medium access control (MAC) control element (CE) structure in accordance with some embodiments.

FIG. 6 illustrates an example of a first portion of a multi-modal representation in accordance with some embodiments.

FIG. 7 illustrates a second portion of the multi-modal representation in accordance with some embodiments.

FIG. 8 illustrates example typical synchronization threshold information for immersive multi-modality virtual reality (VR) applications in accordance with some embodiments.

FIG. 9 illustrates an example packet delay arrangement in accordance with some embodiments.

FIG. 10 illustrates an example inter-flow dependent buffer delay triggering procedure in accordance with some embodiments.

FIG. 11 illustrates an example inter-flow dependent buffer delay calculation procedure in accordance with some embodiments.

FIG. 12 illustrates example data volume calculation information for delay status reporting in accordance with some embodiments.

FIG. 13 illustrates an example data volume calculation information in accordance with some embodiments.

FIG. 14 illustrates an example packet delay arrangement in accordance with some embodiments.

FIG. 15 illustrates an example delay-critical packet data convergence (PDCP) service data unit (SDU) identification procedure in accordance with some embodiments.

FIG. 16 illustrates an example delay-critical PDCP SDU identification arrangement in accordance with some embodiments.

FIG. 17 illustrates an example triggering condition of delay-aware logical channel prioritization (LCP) procedure in accordance with some embodiments.

FIG. 18 illustrates an example procedure for determining whether to trigger DSR in accordance with some embodiments.

FIG. 19 illustrates an example procedure for determining a buffer delay for a first flow in accordance with some embodiments.

FIG. 20 illustrates an example procedure for performing DSR in accordance with a determined reporting granularity in accordance with some embodiments.

FIG. 21 illustrates an example procedure for generating a reporting granularity configuration message in accordance with some embodiments.

FIG. 22 illustrates an example procedure for determining a reporting granularity for DSR in accordance with some embodiments.

FIG. 23 illustrates an example procedure for identifying a flow as delay-critical PDCP SDU in accordance with some embodiments.

FIG. 24 illustrates an example procedure for determining whether to trigger delay-aware LCP mode for an entity in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

The term “based at least in part on” as used herein may indicate that an item is based solely on another item and/or an item is based on another item and one or more additional items. For example, item 1 being determined based at least in part on item 2 may indicate that item 1 is determined based solely on item 2 and/or is determined based on item 2 and one or more other items in embodiments.

Procedures for Third Generation Partnership Project (3GPP) networks to support multi-modal communication services are being developed for supporting various use cases, including extended reality (XR). For example, the networks may process data from multiple sources and/or utilize data for output to multiple output devices. The data utilized for multi-modal communication services may need to be synchronized to be communicated at approximately a same time to allow for proper processing of the data and/or presentation of the outputs of the data. The data for the multi-modal communication services may be scheduled for communication on different channels for communication.

As the data for multi-modal communication services may be associated to different traffic flows, different portions of the data to be synchronized may be provided to different buffers corresponding to the different radio bearers. The data in the different radio bearers may have different corresponding discard timers with different times for expiry of the discard timers. These different times for expiry of the discard timers for different portions of the data to be synchronized could cause issues with the synchronization of the data, such as when portions of the data are discarded prior to being transmitted on the corresponding channels. Approaches described herein can address these issues to maintain, or attempt to maintain, proper synchronization of multi-modal data.

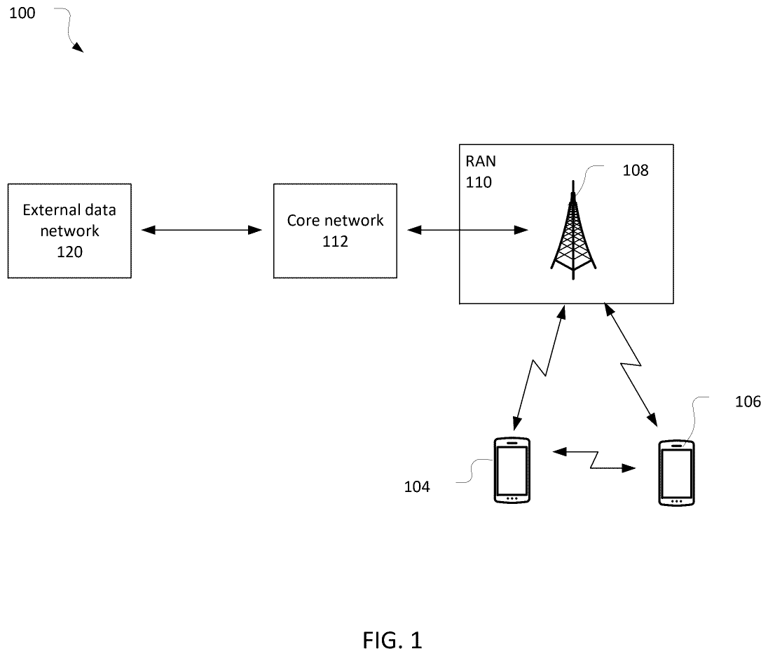

FIG. 1 illustrates a network environment 100 in accordance with some embodiments. The network environment 100 may include a user equipment (UE) 104 communicatively coupled with a base station 108 of a radio access network (RAN) 110. The UE 104 and the base station 108 may communicate over air interfaces compatible with 3GPP TSs such as those that define a Fifth Generation (5G) new radio (NR) system or a later system. The base station 108 may provide user plane and control plane protocol terminations toward the UE 104.

In some embodiments, the UE 104 and base station 108 may establish data radio bearers (DRBs) to support transmission of data over a wireless link between the two nodes. In one example, these DRBs may be used for traffic from extended reality (XR) applications that contains a large amount of data conveying real and virtual images and audio for presentation to a user.

The network environment 100 may further include a core network 112. For example, the core network 112 may comprise a 5th Generation Core network (5GC) or later generation core network. The core network 112 may be coupled to the base station 108 via a fiber optic or wireless backhaul. The core network 112 may provide functions for the UE 104 via the base station 108. These functions may include managing subscriber profile information, subscriber location, authentication of services, or switching functions for voice and data sessions.

In some embodiments, the network environment 100 may also include UE 106. The UE 106 may be coupled with the UE 104 via a sidelink interface. In some embodiments, the UE 106 may act as a relay node to communicatively couple the UE 104 to the RAN 110. In other embodiments, the UE 106 and the UE 104 may represent end nodes of a communication link. For example, the UEs 104 and 106 may exchange data with one another.

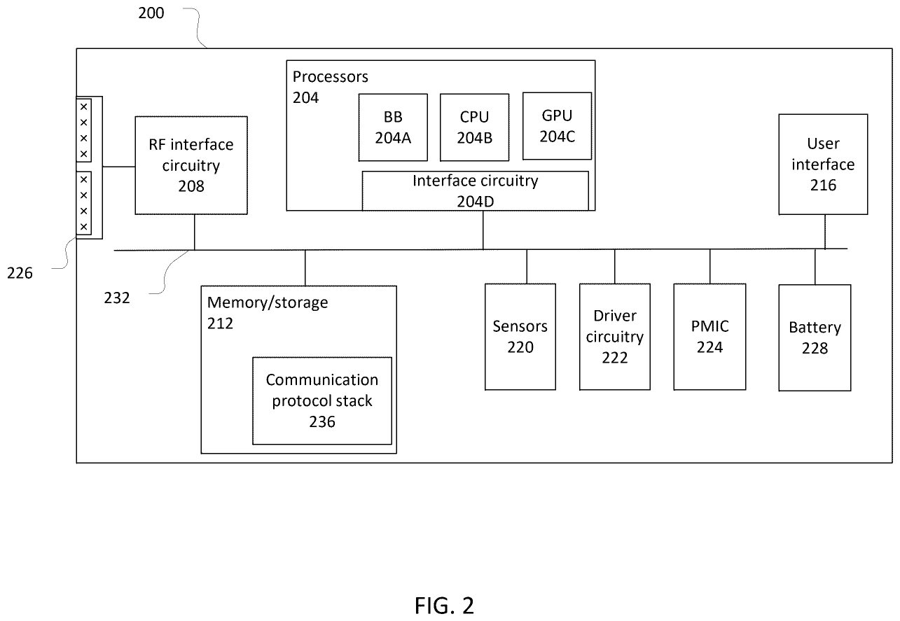

FIG. 2 illustrates a UE 200 in accordance with some embodiments. The UE 200 may be similar to and substantially interchangeable with UE 104 or 106.

The UE 200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 200 may include processors 204, RF interface circuitry 208, memory/storage 212, user interface 216, sensors 220, driver circuitry 222, power management integrated circuit (PMIC) 224, antenna 226, and battery 228. The components of the UE 200 may be implemented as integrated circuits (ICs), portions thereof, discrete electronic devices, or other modules, logic, hardware, software, firmware, or a combination thereof. The block diagram of FIG. 2 is intended to show a high-level view of some of the components of the UE 200. However, some of the components shown may be omitted, additional components may be present, and different arrangement of the components shown may occur in other implementations.

The components of the UE 200 may be coupled with various other components over one or more interconnects 232, which may represent any type of interface, input/output, bus (local, system, or expansion), transmission line, trace, or optical connection that allows various circuit components (on common or different chips or chipsets) to interact with one another.

The processors 204 may include processor circuitry such as, for example, baseband processor circuitry (BB) 204A, central processor unit circuitry (CPU) 204B, and graphics processor unit circuitry (GPU) 204C. The processors 204 may include any type of circuitry or processor circuitry that executes or otherwise operates computer-executable instructions, such as program code, software modules, or functional processes from memory/storage 212 to cause the UE 200 to perform delay-adaptive operations as described herein. The processors 204 may also include interface circuitry 204D to communicatively couple the processor circuitry with one or more other components of the UE 200.

In some embodiments, the baseband processor circuitry 204A may access a communication protocol stack 236 in the memory/storage 212 to communicate over a 3GPP compatible network. In general, the baseband processor circuitry 204A may access the communication protocol stack 236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 208.

The baseband processor circuitry 204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 212 may include one or more non-transitory, computer-readable media that includes instructions (for example, communication protocol stack 236) that may be executed by one or more of the processors 204 to cause the UE 200 to perform various delay-adaptive operations described herein.

The memory/storage 212 includes any type of volatile or non-volatile memory that may be distributed throughout the UE 200. In some embodiments, some of the memory/storage 212 may be located on the processors 204 themselves (for example, memory/storage 212 may be part of a chipset that corresponds to the baseband processor circuitry 204A), while other memory/storage 212 is external to the processors 204 but accessible thereto via a memory interface. The memory/storage 212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 208 may include transceiver circuitry and a radio frequency front module (RFEM) that allows the UE 200 to communicate with other devices over a radio access network. The RF interface circuitry 208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 226 and proceed to filter and amplify (with a low-noise amplifier) the signal. The signal may be provided to a receiver of the transceiver that down-converts the RF signal into a baseband signal that is provided to the baseband processor of the processors 204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 226.

In various embodiments, the RF interface circuitry 208 may be configured to transmit/receive signals in a manner compatible with NR access technologies.

The antenna 226 may include antenna elements to convert electrical signals into radio waves to travel through the air and to convert received radio waves into electrical signals. The antenna elements may be arranged into one or more antenna panels. The antenna 226 may have antenna panels that are omnidirectional, directional, or a combination thereof to enable beamforming and multiple input, multiple output communications. The antenna 226 may include microstrip antennas, printed antennas fabricated on the surface of one or more printed circuit boards, patch antennas, or phased array antennas. The antenna 226 may have one or more panels designed for specific frequency bands including bands in FR1 or FR2.

The user interface 216 includes various input/output (I/O) devices designed to enable user interaction with the UE 200. The user interface 216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 200.

The sensors 220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 222 may include software and hardware elements that operate to control particular devices that are embedded in the UE 200, attached to the UE 200, or otherwise communicatively coupled with the UE 200. The driver circuitry 222 may include individual drivers allowing other components to interact with or control various input/output (I/O) devices that may be present within, or connected to, the UE 200. For example, driver circuitry 222 may include a display driver to control and allow access to a display device, a touchscreen driver to control and allow access to a touchscreen interface, sensor drivers to obtain sensor readings of sensors 220 and control and allow access to sensors 220, drivers to obtain actuator positions of electro-mechanic components or control and allow access to the electro-mechanic components, a camera driver to control and allow access to an embedded image capture device, audio drivers to control and allow access to one or more audio devices.

The PMIC 224 may manage power provided to various components of the UE 200. In particular, with respect to the processors 204, the PMIC 224 may control power-source selection, voltage scaling, battery charging, or DC-to-DC conversion.

A battery 228 may power the UE 200, although in some examples the UE 200 may be mounted deployed in a fixed location and may have a power supply coupled to an electrical grid. The battery 228 may be a lithium ion battery, a metal-air battery, such as a zinc-air battery, an aluminum-air battery, a lithium-air battery, and the like. In some implementations, such as in vehicle-based applications, the battery 228 may be a typical lead-acid automotive battery.

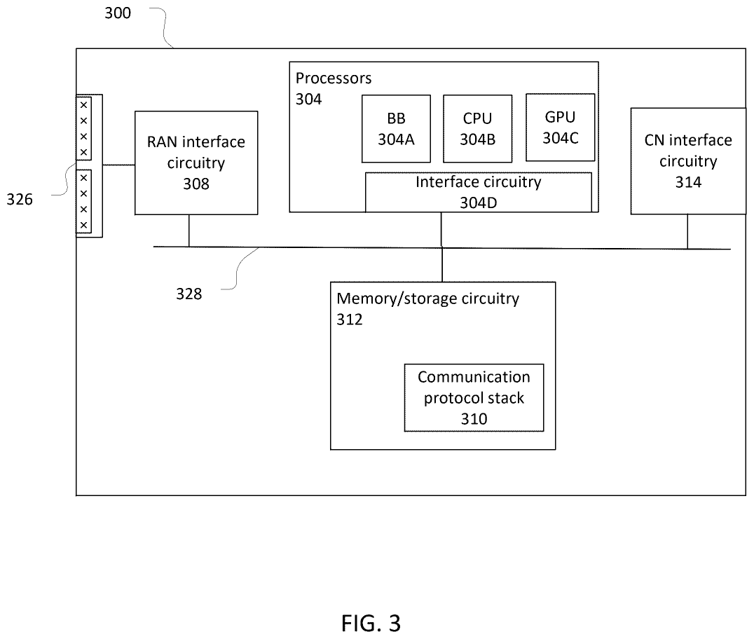

FIG. 3 illustrates a network device 300 in accordance with some embodiments. The network device 300 may be similar to and substantially interchangeable with base station 108 or a device of the core network 112 or external data network 120.

The network device 300 may include processors 304, RF interface circuitry 308 (if implemented as a base station), core network (CN) interface circuitry 314, memory/storage circuitry 312, and antenna structure 326.

The components of the network device 300 may be coupled with various other components over one or more interconnects 328.

The processors 304, RF interface circuitry 308, memory/storage circuitry 312 (including communication protocol stack 310), antenna structure 326, and interconnects 328 may be similar to like-named elements shown and described with respect to FIG. 2.

The processors 304 may include processor circuitry such as, for example, baseband processor circuitry (BB) 304A, central processor unit circuitry (CPU) 304B, and graphics processor unit circuitry (GPU) 304C. The processors 304 may include any type of circuitry or processor circuitry that executes or otherwise operates computer-executable instructions, such as program code, software modules, or functional processes from memory/storage circuitry 312 to cause the network device 300 to perform operations described herein. The processors 304 may also include interface circuitry 304D to communicatively couple the processor circuitry with one or more other components of the network device 300.

The CN interface circuitry 314 may provide connectivity to a core network, for example, a 5th Generation Core network (5GC) using a 5GC-compatible network interface protocol such as carrier Ethernet protocols, or some other suitable protocol. Network connectivity may be provided to/from the network device 300 via a fiber optic or wireless backhaul. The CN interface circuitry 314 may include one or more dedicated processors or FPGAs to communicate using one or more of the aforementioned protocols. In some implementations, the CN interface circuitry 314 may include multiple controllers to provide connectivity to other networks using the same or different protocols.

Approaches described herein may relate to delay status reporting (DSR) (which also may be referred to as “buffer delay information reporting”) for extended reality (XR) Multi-Modal Services. DSR for release 18 (Rel-18) XR may be implemented. In order to assist delay-aware scheduling, mechanisms for buffer delay information reporting may be specified in third generation partnership project (3GPP) Rel-18 work item of XR. The DSR medium access control (MAC) control element (CE) may be triggered when the remaining time of data till the discard timer expiry in a logical channel group (LCG) satisfies a remaining time threshold.

Such reporting may allow the base station (which may include a nodeB, an evolved NodeB (eNB), and/or a next generation NodeB (gNB)) to know how much remaining time is still available for buffered data before it is discarded. The user equipment (UE) may calculate the remaining time based on the packet data convergence protocol (PDCP) discard timer value. The reference time for remaining time report may be determined from the point of the first transmission of the information. The report may include the information of the remaining time till the discard timer expiry (the reference point may be the starting of the uplink shared channel (UL-SCH) for such MAC CE), as well as the data volume (i.e., buffer size) account for such remaining time.

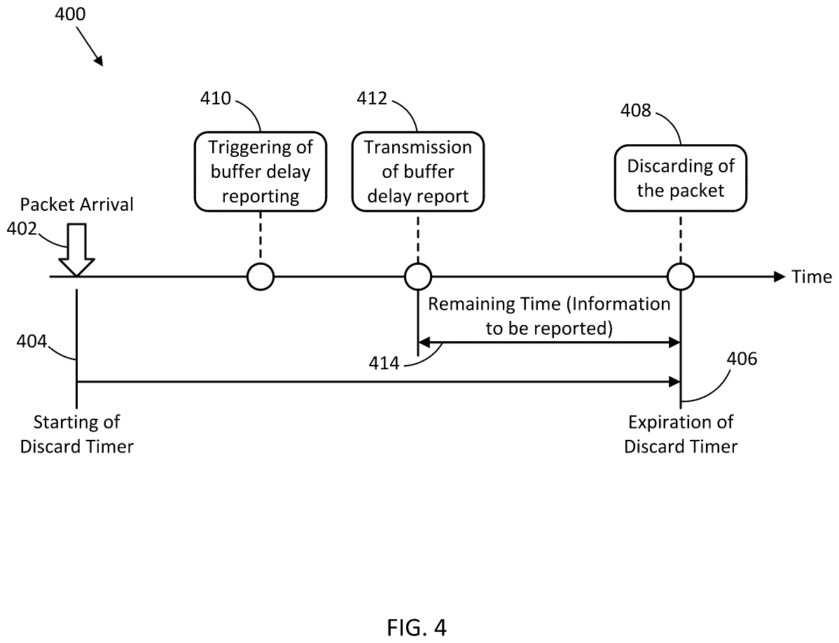

FIG. 4 illustrates an example buffered data delay reporting and discard arrangement 400 in accordance with some embodiments. The buffered data delay reporting and discard arrangement 400 illustrates an example delay reporting and discard system procedure for a data packet placed into a buffer for communication on a data channel (such as a logical channel (LCH)).

The buffered data discard arrangement 400 may include a packet arrival 402, where a data packet is received by a buffer. The data packet may be provided to the buffer for transmission on a channel corresponding to the buffer.

When the data packet arrives a starting 404 of a discard timer for the data packet may occur. For example, a discard timer corresponding to the data packet may start counting down from a discard time or start counting up to a discard time for the data packet. The discard timer may continue to count toward an expiration 406 of the discard timer. The data packet may be discarded at the expiration 406 of the discard timer, as illustrated by the discarding of the packet 408.

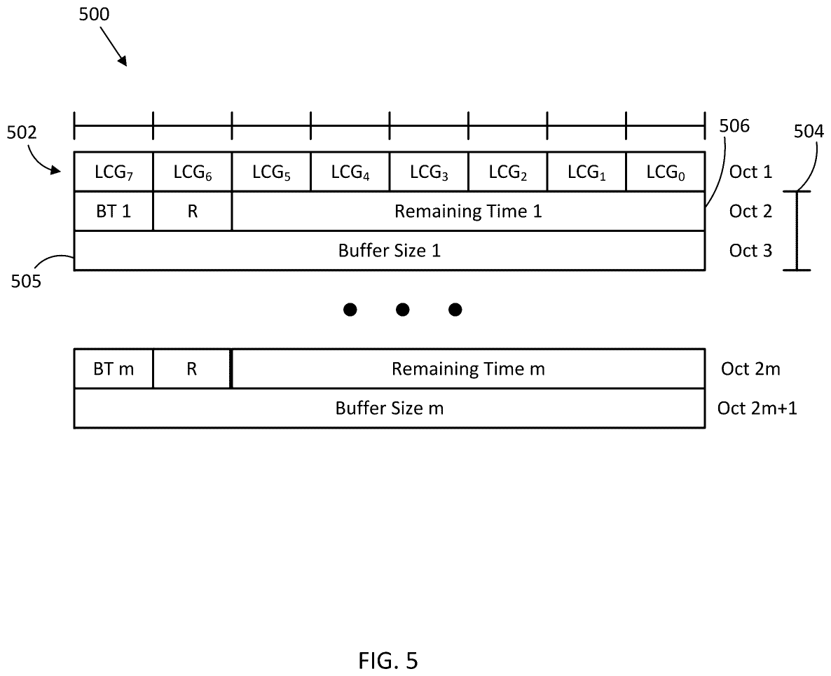

The system implementing the buffer (such as the UE, the base station, and/or the core network) may monitor the discard timer to determine when to trigger a delay status report (which may also be referred to as a “buffer delay report”) or DSR. The buffer delay report may include delay information regarding the buffer, such as remaining time till the discard timer expiry, an amount of data in the buffer, and/or an indication of resources to which the buffer delay information relates. In some embodiments, the delay status report may include one or more of the features of the DSR MAC CE structure described in relation to FIG. 5.

The system may determine to trigger the delay status reporting when a time remaining on the discard timer is less than or equal to a threshold remaining time, as shown by 410. Triggering the delay status reporting may include gathering the information to be included in the delay status report and/or generating the buffer delay report.

After triggering the delay status reporting, the system may wait for a resource to become available for transmission of the delay status report. The system may monitor for a resource to become available for the delay status report and/or transmit a request for having a resource provided for the delay status report. In the illustrated embodiment, the system may determine that a resource has become available and/or has been assigned a resource for the delay status report at 412. The system may transmit the buffer delay report at 412. The buffer delay report may indicate a remaining time 414 of the discard timer when the buffer delay report is transmitted.

FIG. 5 illustrates an example DSR MAC CE structure 500 in accordance with some embodiments. The DSR MAC CE structure 500 may be a structure utilized for a delay status report, such as the delay status report described in relation to FIG. 4. The DSR MAC CE structure 500 may be adopted in Rel-18.

The DSR MAC CE structure 500 may include one or fields 502 that indicate the resource to which the DSR MAC CE structure 500 is directed. In the illustrated embodiments, the one or more fields 502 indicates LCG resources. For example, the one or more fields 502 can indicate from LCG₀ to LCG₇. In some embodiments, a value of 1 may be included in the field of the resource to be indicated.

The DSR MAC CE structure 500 may include one or more information field groups that provide information for data within the indicated structure. For example, the DSR MAC CE structure 500 includes a first information field group 504. The first information field group 504 may include a remaining time field 506. The remaining time field 506 may be used indicate an amount of time till expiry of a discard timer for the indicated byte. The first information field group 504 may include a buffer size field 508. The buffer size field 508 may be used to indicate a size of the buffer, a size of the data within the buffer, and/or some combination thereof.

Many details are still to be defined relate to buffer status reporting (BSR) design, such as the reporting granularity. For Rel-18, the reporting granularity may be based on LCG, since this is more aligned with the existing BSR design. However, other approaches may be implemented, especially when consider the multi-modal services that may be considered in Rel-19 (more details about multi-modal can be found in the next page).

Multi-Modal Services for XR may be provided. Multi-modal communication service may be provided by a fifth generation system (5GS) to support various use cases including XR. In particular, the applications may be able to obtain inputs from more than one sources and/or output to more than one destinations to convey information more effectively.

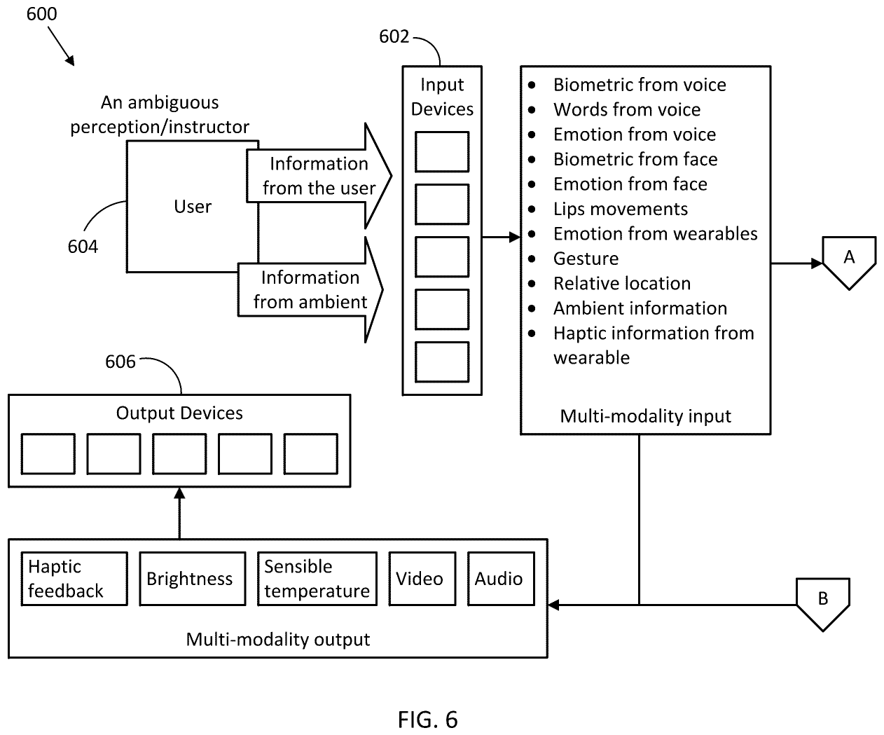

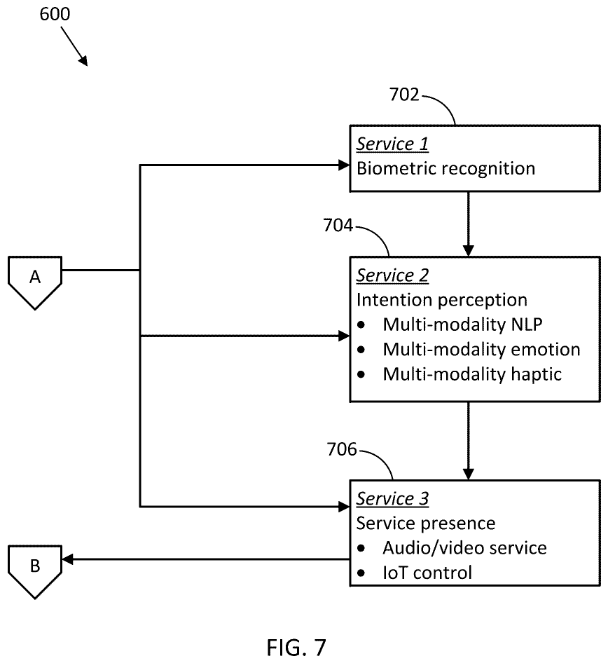

FIG. 6 illustrates an example of a first portion of a multi-modal representation 600 in accordance with some embodiments. FIG. 7 illustrates a second portion of the multi-modal representation 600 in accordance with some embodiments. The multi-modal representation 600 illustrates example elements that may be included in multi-modal communication service in a 5GS.

The multi-modal representation 600 may include one or more input devices 602. The input devices 602 may includes devices that gather information related to a user (such as user 604) and/or a target. The input devices 602 may include cameras, microphones, wearable devices, and/or information-capturing devices (such as devices that capture ambient data). The input devices 602 may capture data that may be utilized for multi-modal services. In the illustrated embodiment, the input devices 602 may capture, as multi-modal inputs, biometric information from voice captures, words from voice captures, emotion information from voice captures, biometric information from face captures, emotion information from face captures, lips movements, emotion information from wearable devices, gesture information, relative location information, ambient information, and/or haptic information from wearable devices.

The multi-modal representation 600 may include one or more services. For example, the multi-modal representation 600 includes a first service 702, a second service 704, and a third service 706 in the illustrated embodiment. The services may be provided by a 5GS, or some portion thereof. For example, the services may be provided by a user equipment, a base station, and/or a core network of a 5GS. In the illustrated embodiment, the first service 702 may perform biometric recognition. The second service 704 may perform intention perception processing, which may include multi-modality natural language processing (NLP), multi-modality emotion processing, and/or multi-modality haptic processing. The third service 706 may perform service presence processing, which may include audio/video service processing, and/or internet of things (IoT) control processing.

The input devices 602 may capture data and provide the captured data to the one or more services. Each of the input devices 602 may provide the captured data to one or more of the services. The services may utilize data from one or more of the input devices 602 for processing. Each of the services may produce one or more multi-modal outputs from the processing. In the illustrated embodiment, the outputs may include haptic feedback, brightness results, sensible temperature results, video, and/or audio.

The multi-modal representation 600 may include one or more output devices 606. The output devices 606 may include video devices, audio devices, smart devices (such as smart curtains, and/or smart lighting), ambient devices (such as heating/cooling devices, scent devices, and/or other environmental control devices), and/or robotic devices, among other devices. The services and/or the input devices 602 may provide outputs to the output devices 606 for controlling the output devices 606.

The multi-modal services may utilize two or more inputs for processing, may utilize inputs from two or more input devices for processing, may utilize two or more processing outputs for controlling an output devices, and/or may control two or more output devices that operate together. The data communicated between the input devices and the services, and/or the data communicated between the services and the output devices may be synchronized to properly provide the multi-modal services. For example, the data being provided from the input devices to the services, from the input devices to the output devices, and/or the services to the output devices may be transmitted at approximately a same time for proper operation of the multi-modal services. If the data is not transmitted at the transmitted at approximately the same time (such as when data is discarded at expiry of a discard timer of a buffer), the multi-modal services may be degraded or fail.

For applications such as immersive virtual reality (VR), synchronization between different media components may be critical for optimization of user experiences. In particular, a synchronization threshold can be defined between two media components.

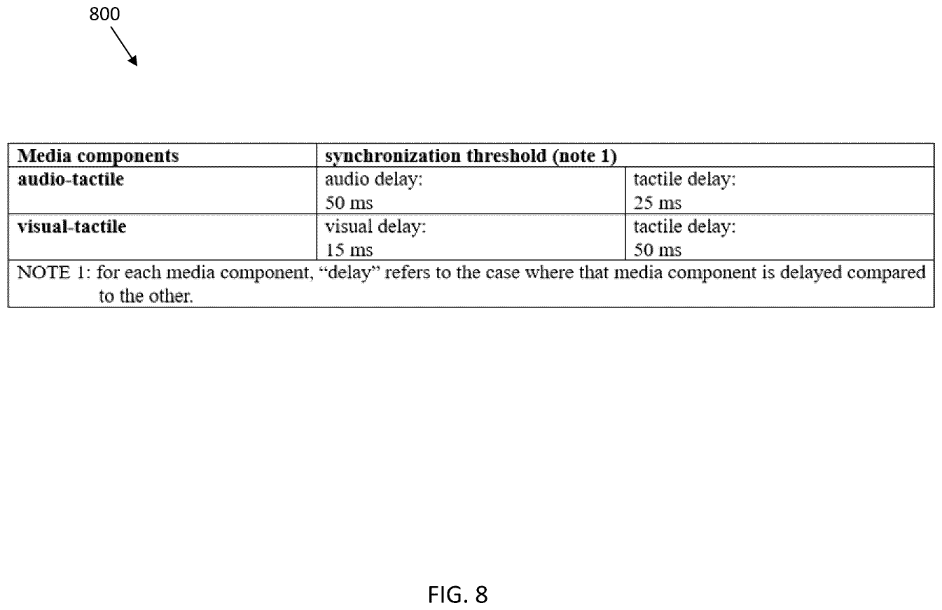

FIG. 8 illustrates example typical synchronization threshold information for immersive multi-modality VR applications in accordance with some embodiments. In particular, FIG. 8 illustrates a table 800 providing synchronization threshold information for some media components for immersive multi-modality VR applications.

The table 800 provides synchronization threshold information for audio-tactile and visual-tactile media components. For audio-tactile, the synchronization threshold for audio delay may be 50 milliseconds (ms) and the tactile delay may be 25 ms. For visual-tactile, the synchronization threshold for visual delay 15 ms and the tactile delay may be 50 ms. If the differences in communicating the media component as compared to other related components is greater than the corresponding synchronization threshold, the performance of the multi-modal service may be degraded and/or the multi-media service may fail.

To support synchronization requirement among multiple data flows from different sources, the application function (AF) may provide at the same time, service requirements, for each media that comprise the multi-modal service, a Multi-modal Service identifier (ID) and quality of service (QOS) monitoring requirements for multiple internet protocol (IP) data flows associated to a multi-modal service. The policy control function (PCF) may use this information to derive the correct policy and charging control (PCC) rules and apply QoS policies for data flows that are part of a specific multi-modal application, and may generate the authorized QoS Monitoring policy for these service data flows.

A few approaches about how the information of multi-modal synchronization requirement can be made available at radio access network (RAN)/user equipment (UE) have been proposed, and how it could be configured. RAN enhancement to address multi-modal synchronization requirement is a potential topic for release 19 (Rel-19).

Buffer delay information reporting for multi-modality is an issue that may be addressed by approaches described herein. By considering buffer delay reporting jointly with multi-modal services, this may be beneficial for the base station (such as the gNB) to get the buffer delay information associating to a group of traffic flows that have synchronization requirement. For instance, when a group of traffic flows that are required to be synchronized, if the base station can know the most urgent delivery deadline among them, the base station may be able to allocate the resource to accommodate these traffics in time. One could argue that if these flows mapped to the same LCG, then per-LCG reporting of buffer delay reporting may be sufficient. However, it cannot be guaranteed that the base station would configure traffic flows with synchronization requirement into the same LCG. In particular, LCG is typically configured based on QoS requirement rather than synchronization requirement. Accordingly, an issue to that may be addressed by approaches herein is how to enable reporting of buffer delay information for a group of multi-modal traffic flows with synchronization requirement.

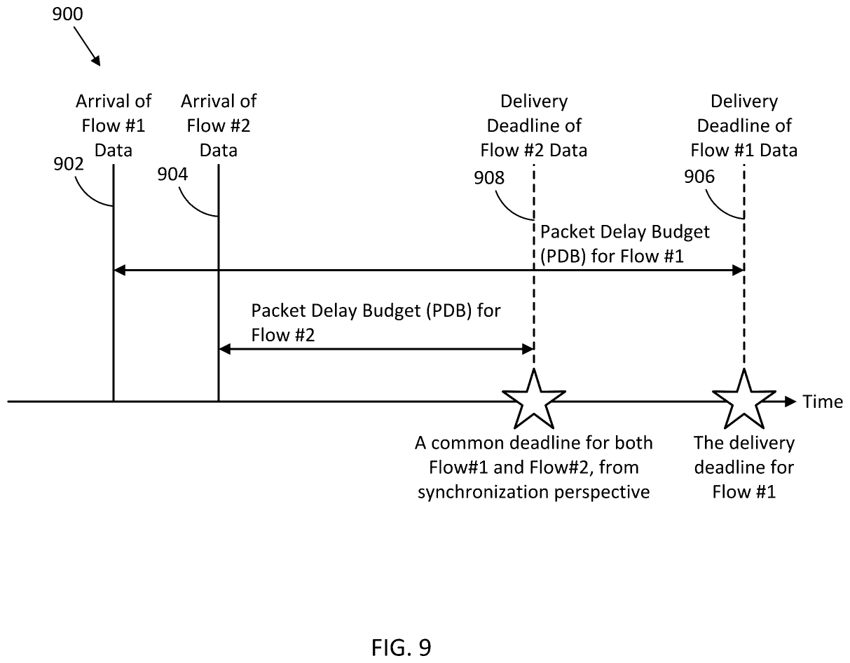

FIG. 9 illustrates an example packet delay arrangement 900 in accordance with some embodiments. The packet delay arrangement 900 illustrates an example timing arrangement for two separate flows (which may refer to traffic flows of data) that are to be synchronized for multi-modal services.

The packet delay arrangement 900 illustrates arrivals and delivery deadlines of a first flow data and a second flow data with respect to buffers. For example, the first flow data may arrive at a first buffer of a device at 902. The first buffer may correspond to a first LCH and/or a first LCG to be utilized for communication of the first flow data from the device. The second flow data may arrive at a second buffer of the device at 904. The second buffer may correspond to a second LCH and/or a second LCG to be utilized for communication of the second flow data from the device.

The device may initiate a count of first discard timer for the first flow data when the first flow data arrives at the first buffer at 902. The first discard timer for the first flow data may expire at a delivery deadline 906. The first flow data may be scheduled to be discarded at the delivery deadline 906, where the first flow data may no longer be in the buffer and/or available for communication after the delivery deadline 906.

The device may initiate a count of a second discard timer for the second flow data when the second flow data arrives at the second buffer at 904. The second discard timer for the second flow data may expire at a delivery deadline 908. The second flow data may be scheduled to be discarded at the delivery deadline 908, where the second flow data may no longer be in the buffer and/or available for communication after the delivery deadline 908.

For synchronization with multi-modal services, data that are synchronized may be required to be received within a synchronization threshold of each other. In the illustrated embodiment, the first flow data and the second flow data may be synchronized for multi-modal services. However, a time difference between the delivery deadline 906 for the first flow data and the delivery deadline 908 for the second flow data may be greater than the synchronization threshold, which could cause the multi-modal services to be degraded and/or to fail. Accordingly, it may be beneficial to avoid separate delivery deadlines for data that are inter-dependent (i.e., are to be synchronized for multi-modal services). Accordingly, it may be desirable to have a common deadline at the delivery deadline 908 for both the first flow data and the second flow data, from the synchronization perspective, in the illustrated embodiment to avoid the time difference between the communication of the first flow data and the second flow data exceeding the synchronization threshold.

A first approach (which may be referred to as “approach 1”) may involve inter-flow dependent delay status report triggering. In this approach, new triggering conditions of delay status information reporting may be introduced. In particular, the triggering condition for one traffic flow may be related to the status of another traffic flow, such as another data radio bearer (DRB)/LCH/QOS Flow.

Specifically, the delay status information reporting for an LCH/LCG may be triggered when a condition relating to the status of another LCH/LCG is met. For example, the delay status information reporting for an LCH/LCG may be triggered when data becomes available in the buffer of at least one other LCH/LCG, the remaining time for the data buffered in at least one other LCH/LCG satisfies a threshold, the buffer delay information reporting for at least one other LCHs/LCGs is triggered, the buffer delay difference between the LCH/LCG and at least one other LCHs/LCGs satisfies a threshold, and/or the synchronization threshold between two or more modalities is less than the packet delay budget (PDB)/protocol data unit set delay budget (PSDB) for one of the LCHs/LCGs/QoS flows.

For this first approach, the buffer delay information reporting for an LCH/LCG may still be triggered by any other condition, such as its own status. Additionally, for this first approach, the “at least one other LCH/LCG” is not any LCH or LCG. Some dependency relationship should be pre-configured between the flow on the LCH/LCG and the flow on the at least one other LCH/LCG. For example, the flow on the LCH/LCG and the at least one other LCH/LCG may belong to the same “Modality-group.” Flows belonging to the same modality-group may assigned a same multi-modal service ID, which may indicate that the flows are inter-dependent and/or that the flows are to be synchronized for multi-modal service.

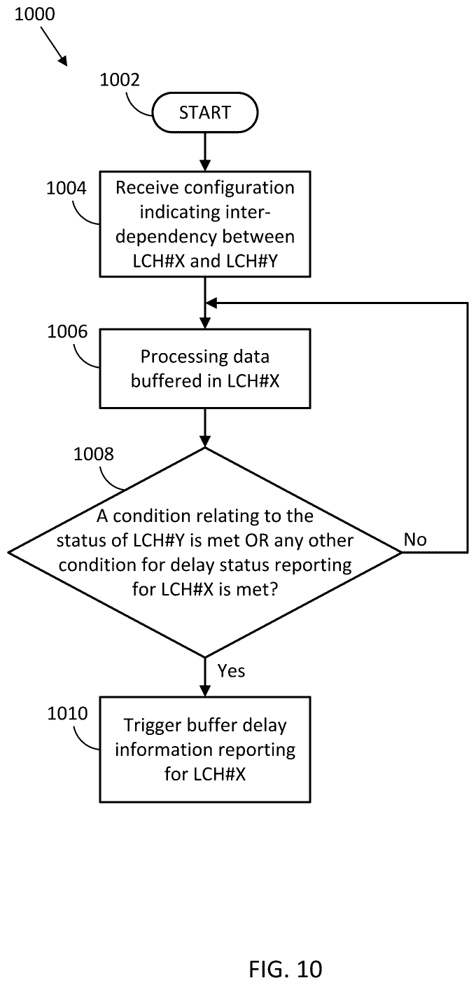

FIG. 10 illustrates an example inter-flow dependent buffer delay triggering procedure 1000 in accordance with some embodiments. For example, the procedure 1000 illustrates an example of the first approach that can be utilized for having the triggering condition of one flow being related to the status of another flow. In the illustrated embodiment, first data may be in LCH #X and second data may be in LCH #Y. It should be understood that the same procedure 1000 may be performed for data on other constructs, such as data in LCGs, data on DRBs, and/or data on QoSs.

The procedure 1000 may start at 1002. The procedure 1000 may include the device performing the procedure 1000 receiving a configuration indicating inter-dependency between LCH #X and LCH #Y in 1004. For example, the configuration may indicate that the first data in LCH #X is inter-dependent with the second data in LCH #Y. The device may determine that the first data and the second data are inter-dependent, and that the first data and the second data are to be synchronized based on the configuration.

The procedure 1000 may include the device processing the data in LCH #X in 1006. For example, the first data may arrive in LCH #X and the device may process the data.

The procedure 1000 may include determining whether a condition relating to the status of LCH #Y is met or any other condition for delay status reporting for LCH #X in 1008. For example, the device may determine whether the second data becomes available in LCH #Y, whether the remaining time for the second data buffered in LCH #Y satisfies a threshold, the delay status information reporting for the LCH #Y is triggered, the buffer delay difference between the first data in LCH #X and the second data in LCH #Y satisfies a threshold, and/or the synchronization threshold between two or more modalities is less than the packet delay budget (PDB)/protocol data unit set delay budget (PSDB) for the LCH #X and the LCH #Y. Further, the device may determine whether any of the other conditions for triggering delay status reporting for LCH #X based on LCH #X (such as the time till expiry of the discard timer for the first data in the LCH #X being less than or equal to a threshold) is met. The device may be configured to monitor for one or more of these conditions. If one or more of the configured conditions are not met, the procedure 1000 may continue to cycle through 1006 and 1008 till the data buffer in LCH #X is transmitted or the condition is met.

If one or more of the configured conditions in 1008 are met, the procedure 1000 may proceed to 1010. The procedure 1000 may include triggering delay status information reporting for LCH #X in 1010. For example, the device may trigger delay status reporting for the data in LCH #X if one or more of the configured conditions in 1008.

A second approach (which may be referred to as “approach 2”) may involve inter-flow dependent buffer delay calculation. In this approach, buffer delay calculation of a traffic flow/QoS Flow/DRB/LCH may be conditionally based on the discard timer value of another traffic flow/QoS Flow/DRB/LCH.

Specifically, the buffer delay information calculation for a traffic flow/DRB/LCH may be by default based on the discard timer configured for the corresponding DRB of this LCH, and/or when a condition relating to the status of another traffic flow/QoS flow/DRB/LCH/LCG is met, the buffer delay information calculation for this LCH can be based on the discard timer configured for the corresponding DRB of another traffic flow/QoS flow/LCH. The condition(s) may be one or more of the conditions listed in Approach 1, e.g., when data becomes available in the buffer of another traffic flow/DRB/LCH/LCG.

The “at least one other LCH/LCG” is not any LCH or LCG. Some dependency relationship should be preconfigured. For example, they may belong to the same “Modality-group.” Flows belonging to the same modality-group may assigned a same multi-modal service ID, which may indicate that the flows are inter-dependent and/or that the flows are to be synchronized for multi-modal service.

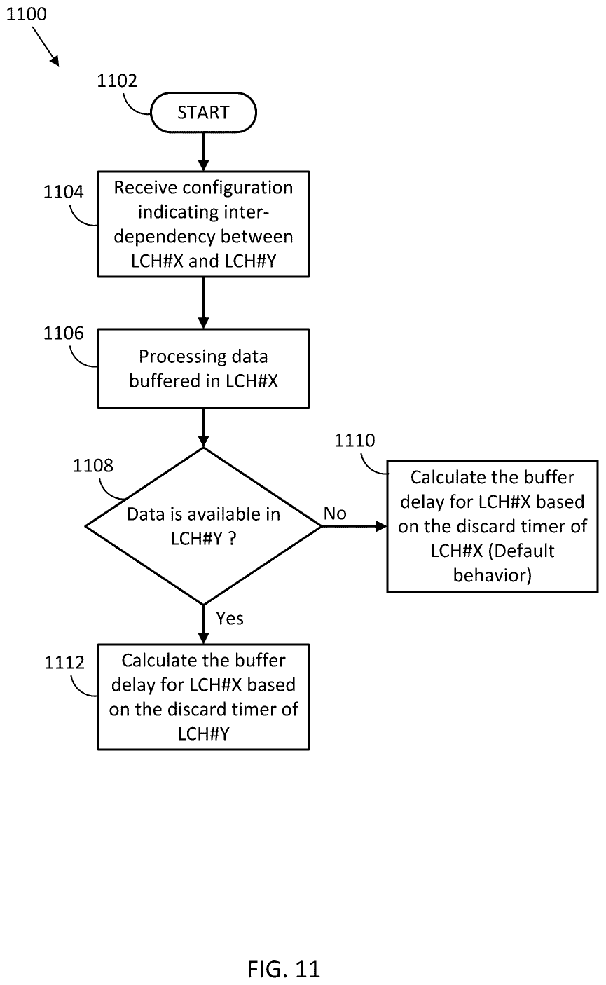

FIG. 11 illustrates an example inter-flow dependent buffer delay calculation procedure 1100 in accordance with some embodiments. For example, the procedure 1100 illustrates an example of the second approach that can be utilized for inter-flow dependent buffer delay calculation. In the illustrated embodiment, first data may be in LCH #X and second data may be in LCH #Y. It should be understood that the same procedure 1100 may be performed for data on other constructs, such as data in LCGs, data on DRBs, and/or data on QoSs. The procedure 1100 illustrated is configured with the condition relating to the status of the other flow being that data is available in the buffer of the other flow. It should be understood that the procedure 1100 may be configured for one or more of the conditions described in relation to approach 1 above.

The procedure 1100 may start at 1102. The procedure 1100 may include the device performing the procedure 1100 receiving a configuration indicating inter-dependency between LCH #X and LCH #Y in 1104. For example, the configuration may indicate that the first data in LCH #X is inter-dependent with the second data in LCH #Y. The device may determine that the first data and the second data are inter-dependent, and that the first data and the second data are to be synchronized based on the configuration.

The procedure 1100 may include the device processing the data in LCH #X in 1106. For example, the first data may arrive in LCH #X and the device may process the data.

The procedure 1100 may include determining whether the second data is available in LCH #Y in 1108. For example, the device may determine whether the second data is available in LCH #Y while the first data is available in LCH #X.

If the second data is not available in LCH #Y in 1108, the procedure 1100 may proceed to 1110. The procedure 1100 may include calculating the buffer delay for LCH #X based on the discard timer of LCH #X in 1110. This may be the default behavior for the buffer delay calculation.

If the second data is available in LCH #Y in 1108, the procedure 1100 may proceed to 1112. The procedure 1100 may include calculating the buffer delay for LCH #X based on the discard timer of LCH #Y in 1112. In some embodiments, the buffer delay for LCH #Y may be shorted than the buffer delay for LCH #X, which calculating the buffer delay for LCH #X based on LCH #Y may cause the calculated buffer delay for both LCH #X and LCH #Y to indicate prior to any of the data being discarded from LCH #X and LCH #Y.

A third approach (which may be referred to as “approach 3”) may involve buffer delay reporting based on modality-group. For the third approach, it may be assumed that the UE has multiple LCHs in the same Modality-Group (i.e., the data from these LCHs have synchronization requirement). However, the LCHs are not configured in the same LCG.

For a first option of the third approach, the network may configure the reporting granularity of the buffer delay reporting, it can be per LCG, per LCH, or per Modality Group. Different type of message formats (e.g., MAC CE formats) can be introduced to support buffer delay reporting based on the granularity of LCG, LCH, QOS flow, or modality group. For LCG, one or more “Logical Channel Group ID” may be included in the message to indicate which LCG the reported buffer delay is referring to. For LCH, one or more “Logical Channel ID” may be included in the message to indicate which LCH the reported buffer delay is referring to. For QoS flow, one or more “QoS Flow ID” may be included in the message to indicate which QoS flow the reported buffer delay is referring to. For modality group, one or more “Modality Group ID” may be included in the message to indicate which modality group the reported buffer delay is referring to.

For a second option of the third approach, the UE may determine which reporting granularity should be used based on certain conditions. As a first example, if the LCH that triggers buffer delay reporting belongs to a modality group, then reporting based on modality group may be used. Otherwise, if the LCH that triggers buffer delay reporting does not belong to a modality group, then reporting based on LCG may be applied. As a second example, if the LCH that triggers buffer delay reporting belongs to a modality group, but data is not available in other LCHs in the same modality group, then reporting based on LCG may be applied. The first option of the third approach and the second option of the third approach may be independent.

In some instances, the LCHs for traffic flows that require synchronization are configured in the same LCGs, therefore the buffer delay reporting granularity may be configured as per LCG is sufficient for the base station to get the buffer delay information required for uplink (UL) scheduling that can fulfil synchronization.

In some instances, the LCHs for traffic flows that require synchronization are configured in different LCGs, therefore the buffer delay reporting granularity may be configured as per modality-group, thus the base station to get the buffer delay information required for UL scheduling that can fulfil synchronization. In some instances, if the reporting granularity is based on per-LCH or per QoS Flow, since the base station knows which traffic flows have synchronization requirement, it can figure out the common buffer delay for the group of traffic flows that require synchronization.

Approaches described herein may consider data volume calculation for DSR. “Delay-Critical PDCP service data units (SDUs)” is defined as follows. In particular, Delay-critical PDCP SDU: if pdu-SetDiscard is not configured, a PDCP SDU for which the remaining time till discardTimer expiry is less than the remainingTimeThreshold. If pdu-SetDiscard is configured, a PDCP SDU belonging to a packet data unit (PDU) Set of which at least one PDCP SDU has the remaining time till discardTimer expiry less than the remainingTimeThreshold. The purpose of introducing “Delay-Critical PDCP SDU” is to calculate buffer size for the DSR MAC CE.

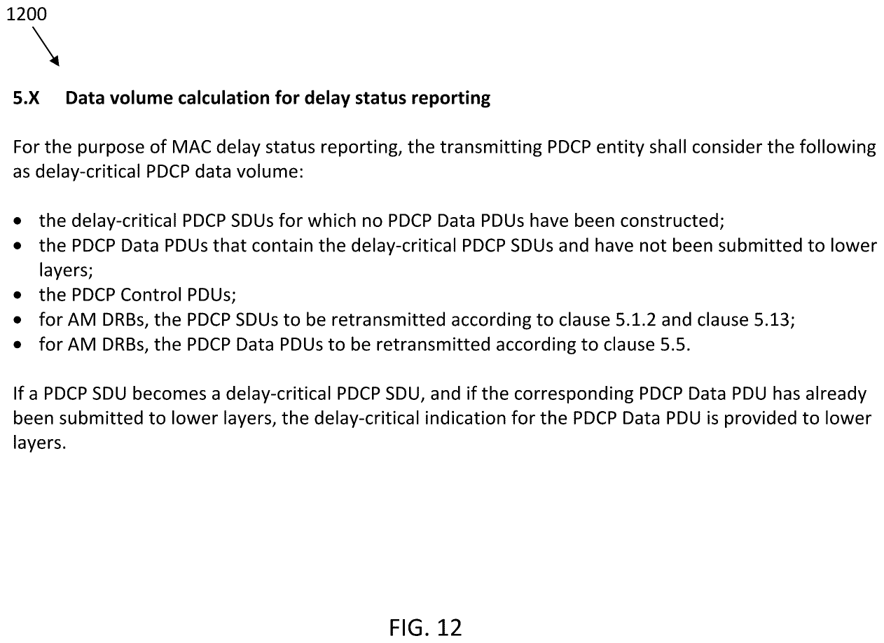

FIG. 12 illustrates example data volume calculation information 1200 for delay status reporting in accordance with some embodiments. For example, the data volume calculation information 1200 may indicate, for the purpose of medium access control (MAC) delay status reporting, when a transmitting PDCP entity may consider data units as delay-critical PDCP data volume.

“Delay-Critical radio link control (RLC) SDUs” is defined as follows. In particular, delay-critical RLC SDU: RLC SDU corresponding to a PDCP PDU indicated as delay-critical by PDCP.

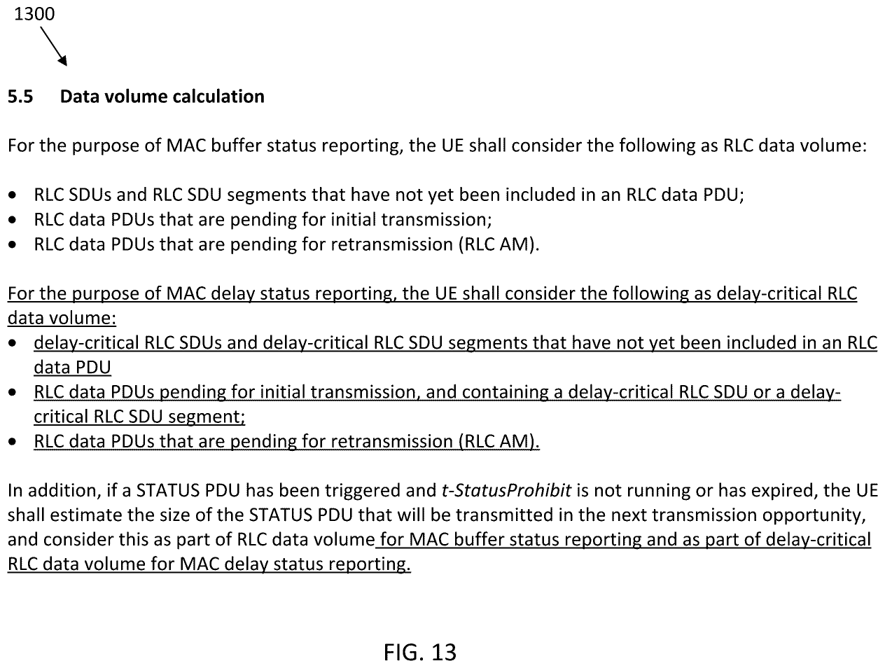

FIG. 13 illustrates an example data volume calculation information 1300 in accordance with some embodiments. For example, the data volume calculation information 1300 illustrates when a UE may, for the purpose of MAC delay status reporting, consider data units as delay-critical RLC data volume.

Approaches described herein may consider delay-aware logical channel prioritization (LCP). On top of DSR, the UE may also use the “remaining time” information to improve scheduling and/or logical channel prioritization (LCP) in Rel-19.

Presuming such mechanism is to be introduced, an LCH/LCG/QOS flow identifier (QFI) may operate in one of the following modes for LCP. A default mode, where the LCP parameters are based on default configurations. A delay-aware LCP mode, where a set of special LCP parameters may be applied. In particular, “delay-aware (or delay-based) LCP mode” for an LCH/LCG/QFI may be triggered when the remaining time of an LCH/LCG/QFI drops below a threshold. When it is triggered, the UE may adapt some parameters of the LCH/LCG/QFI, such as the priority of the LCH, the prioritized bit rate (PBR) of the LCH, and/or the mapping restrictions of the LCH. There are many other possibilities that can be utilized as triggering for delay-aware (or delay-based) LCP mode.

On the other hand, it is also prospective that LCP enhancement may be introduced to support multi-modal synchronization requirement. LCP enhancement that can ensure data from LCHs corresponding multi-modal flows with synchronization requirement can be multiplexed into the same MAC PDU have been proposed, which minimizes the delay among these flows in the air-interface.

An issue to be addressed may relate to buffer size for DSR of multi-modal flows. By considering DSR for flows with synchronization requirement jointly, this may be beneficial for the base station to schedule resources in a proper manner to make sure these flows can be delivered together. DSR for multi-modality flows is being considered. However, it has not been mentioned how to deal with buffer size calculation.

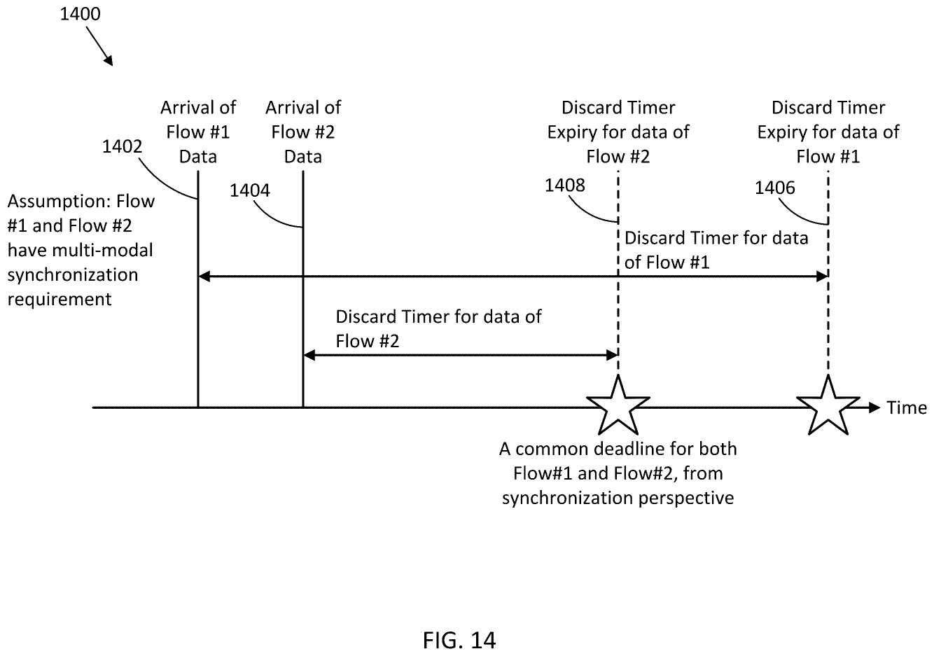

In FIG. 14, when DSR for the data of Flow #2 is triggered, it may not consider the data of Flow #1 as “Delay-Critical” for DSR, so the UE may not report accurate data volume in the DSR required by synchronization. A second issue that may be addressed by approaches described herein may be how the buffer size of “delay-critical” packets should be calculated/considered to accommodate multi-modal flows.

FIG. 14 illustrates an example packet delay arrangement 1400 in accordance with some embodiments. The packet delay arrangement 1400 illustrates an example timing arrangement for two separate flows (which may refer to traffic flows of data) that are to be synchronized for multi-modal services. For example, a first data flow (which may be referred to as “Flow #1”) and a second data flow (which may be referred to as “Flow #2”) may have multi-modal synchronization requirement.

The packet delay arrangement 1400 illustrates arrivals and delivery deadlines of a first flow data and a second flow data with respect to buffers. For example, the first flow data may arrive at a first buffer of a device at 1402. The first buffer may correspond to a first LCH and/or a first LCG to be utilized for communication of the first flow data from the device. The second flow data may arrive at a second buffer of the device at 1404. The second buffer may correspond to a second LCH and/or a second LCG to be utilized for communication of the second flow data from the device.

The device may initiate a count of first discard timer for the first flow data when the first flow data arrives at the first buffer at 1402. The first discard timer for the first flow data may expire at a delivery deadline 1406. The first flow data may be scheduled to be discarded at the delivery deadline 1406, where the first flow data may no longer be in the buffer and/or available for communication after the delivery deadline 1406.

The device may initiate a count of a second discard timer for the second flow data when the second flow data arrives at the second buffer at 1404. The second discard timer for the second flow data may expire at a delivery deadline 1408. The second flow data may be scheduled to be discarded at the delivery deadline 1408, where the second flow data may no longer be in the buffer and/or available for communication after the delivery deadline 1408.

DSR may be triggered when a remaining time till expiration of a discard timer is equal to or less than a threshold, such as described in relation to FIG. 4. A delay status report generated as part of a DSR may include an indication of data volume. In legacy approaches, the data volume indicated in the delay status report only considered the data in the flow triggered. However, with multi-modal synchronization requirement, data that is inter-dependent are to be synchronized to be communicated at the same time. The data volume only considering the data in the flow triggered can be insufficient.

A third issue addressed by approaches described herein may be related to delay-aware logical channel prioritization (LCP). Assuming that if Delay-Aware LCP is adopted in Rel-19, the triggering condition for adaptation of an LCH may be based on the remaining time relating to the PDCP discard timer of the LCH. When the LCH is corresponding to a traffic flow that has multi-modal synchronization requirement with another traffic flow, the triggering conditions of delay-aware LCP may also take this into account. In the example illustrated in FIG. 14, the LCH of Flow #1 may only trigger Delay-Aware LCP adaptation when its own remaining time drops below a threshold, which may be too late to achieve synchronization if the discard timer for data from LCH of Flow #2 stops earlier. The third issue that may be addressed by approaches described herein may be how to trigger delay-aware LCP by taking multi-modal synchronization requirement into account.

A fourth approach (which may be referred to as “approach 4”) may be related to delay-critical PDCP SDU Identification. For the fourth approach, it may be assumed that a first LCH/LCG/Radio Bearer (RB) has a discard timer #1. Further, it may be assumed that a second LCH/LCG/Radio Bearer (RB) has a discard timer #2. The traffic flows corresponding to these two LCH/LCG/RBs may have multi-modal synchronization requirement. Further, it may be assumed that discard timer #1 may expire earlier than Discard timer #2.

For the fourth approach, the definition of “delay-critical PDCP SDU” in the second LCH/LCG/RB can be extended to also cover the data that has remaining time till expiry of Discard timer #1 configured for the first LCH/LCG/RB (i.e., the remaining time for data on a PDCP entity is calculated based on the discard timer of another PDCP entity). Note that this may include the data in the second LCH/LCG/RB whose remaining time is zero or negative value when the Discard timer #1 is used as the reference for remaining time calculation. In some embodiments, as soon as DSR is triggered by the first LCH/LCG/RB, all data in the second LCH/LCG/RB may be directly considered as “delay-critical” for DSR buffer size calculation.

An example specification impact may be as follows. Delay-critical PDCP SDU: if pdu-SetDiscard is not configured, a PDCP SDU for which the remaining time till discardTimer expiry (or, if applicable, the remaining time till discardTimer of another PDCP entity linked for multi-modal synchronization) is less than the remainingTimeThreshold. If pdu-SetDiscard is configured, a PDCP SDU belonging to a PDU Set of which at least one PDCP SDU has the remaining time till discardTimer expiry (or, if applicable, the remaining time till discardTimer of another PDCP entity linked for multi-modal synchronization) less than the remaining TimeThreshold.

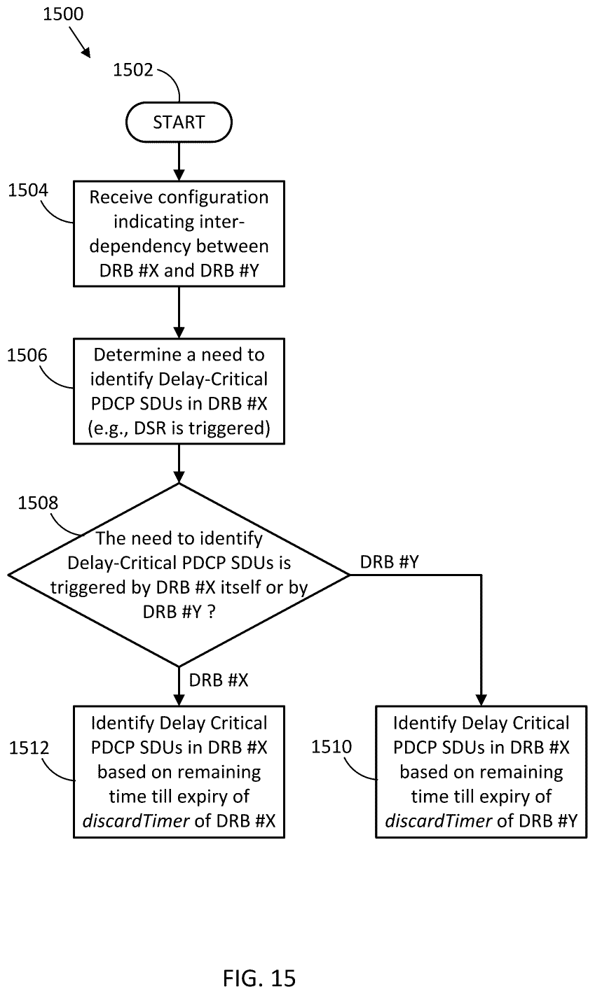

FIG. 15 illustrates an example delay-critical PDCP SDU identification procedure 1500 in accordance with some embodiments. The logic flow illustrated by the procedure 1500 may represent the behavior of a single PDCP entity (e.g., PDCP of DRB #X) instead of the UE, so it may only identify delay-critical SDUs in DRB #X. However, the DSR may take delay-critical SDUs from both DRB #X and DRB #Y into account.

The procedure 1500 may start at 1502. The procedure 1500 may include the device performing the procedure 1500 receiving a configuration indicating inter-dependency between DRB #X and DRB #Y in 1504. For example, the configuration may indicate that the first data in DRB #X is inter-dependent with the second data in DRB #Y. The device may determine that the first data and the second data are inter-dependent, and that the first data and the second data are to be synchronized based on the configuration.

The procedure 1500 may include determining a need to identify delay-critical PDCP SDUs in DRB #X in 1506. The need to identify delay-critical PDCP SDUs in DRB #X may occur when DSR is triggered in some embodiments. For example, the device may determine that delay-critical PDCP SDUs are to be identified based on DSR being triggered in some embodiments.

The procedure 1500 may include determining whether the need to identify delay-critical PDCP SDUs is triggered by DRB #X itself or by DRB #Y in 1508. For example, the device may determine whether the need to identify delay-critical PDCP SDUs in DRB #X is triggered by the DSR of the DRB #X being triggered or the DSR of the DRB #Y being triggered.

If the device determines that the need to identify delay-critical PDCP SDUs is triggered by DRB #Y in 1508, the procedure 1500 may proceed to 1510. The procedure 1500 may include identifying delay critical PDCP SDUs in DRB #X based on the remaining time till expiry of the discard timer of DRB #Y. For example, the device may identify delay critical PDCP SDUs in DRB #X when a remaining time of the discard timer of DRB #Y is equal to or less than a threshold value.

If the device determines that the need to identify delay-critical PDCP SDUs is triggered by DRB #X in 1508, the procedure 1500 may proceed to 1512. The procedure 1500 may include identifying delay critical PDCP SDUs in DRB #X based on the remaining time till expiry of the discard timer of DRB #X. For example, the device may identify delay critical PDCP SDUs in DRB #X when a remaining time of the discard timer of DRB #X is equal to or less than a threshold value.

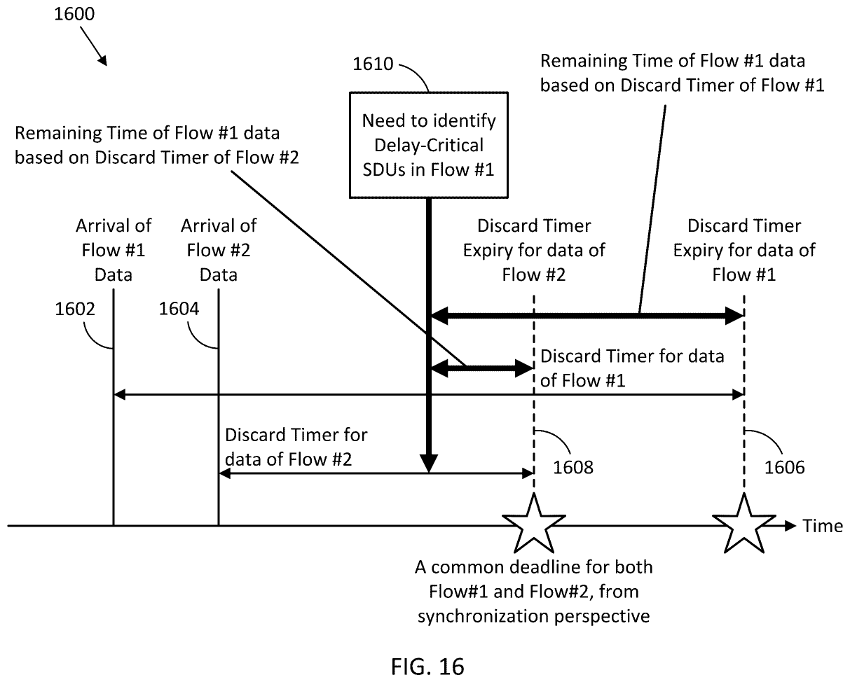

FIG. 16 illustrates an example delay-critical PDCP SDU identification arrangement 1600 in accordance with some embodiments. The delay-critical PDCP SDU identification 1600 illustrates an example timing of identifying delay-critical SDUs in accordance with the procedure 1500 (FIG. 15).

The packet delay arrangement 1600 illustrates arrivals and delivery deadlines of a first flow data and a second flow data with respect to buffers. For example, the first flow data may arrive at a first buffer of a device at 1602. The first buffer may correspond to a first LCH and/or a first LCG to be utilized for communication of the first flow data from the device. The second flow data may arrive at a second buffer of the device at 1604. The second buffer may correspond to a second LCH and/or a second LCG to be utilized for communication of the second flow data from the device.

The device may initiate a count of first discard timer for the first flow data when the first flow data arrives at the first buffer at 1602. The first discard timer for the first flow data may expire at a delivery deadline 1606. The first flow data may be scheduled to be discarded at the delivery deadline 1606, where the first flow data may no longer be in the buffer and/or available for communication after the delivery deadline 1606.

The device may initiate a count of a second discard timer for the second flow data when the second flow data arrives at the second buffer at 1604. The second discard timer for the second flow data may expire at a delivery deadline 1608. The second flow data may be scheduled to be discarded at the delivery deadline 1608, where the second flow data may no longer be in the buffer and/or available for communication after the delivery deadline 1608.

In the illustrated embodiment, the discard timer for the second flow data may expire prior to the discard timer for the first flow data. DSR for the second flow data may be triggered at time 1610 based on a remaining time on the discard timer for the second flow data being equal to a threshold value. For data flows that are inter-dependent for multi-modal services, the DSR for all of the data flows that are inter-dependent and available may be triggered at an earliest DSR of the inter-dependent data flows. In the illustrated embodiment, the first data flow and the second data flow have been configured as being inter-dependent. As the second data flow has the DSR being triggered the earliest, the DSR for the second data flow may be triggered at the same time for synchronization.

A fifth approach (which may be referred to as “approach 5”) may be related to triggering conditions of delay-aware LCP. For the fifth approach, by default, the delay-aware LCP mode for the first LCH/LCG/QFI is triggered when its remaining time satisfies a threshold. If the multi-modal synchronization between the first LCH/LCG/QFI and the second LCH/LCG/QFI is needed, the delay-aware mode of the first LCH/LCG/QFI may be triggered when its remaining time based on the discard timer expiry of the second LCH/LCG/QFI satisfies a threshold. In other words, there may be at least the two delay-aware LCP mode triggering conditions for an LCH/LCG/QFI. A first triggering condition may be based on the remaining time with respect to its own discard timer that is running. A second triggering condition may be based on the status of remaining time with respect to discard timer that is running of another DRB.

The UE may switch the Triggering Condition for an LCH/LCG/QFI based on certain status relating to another LCH/LCG/QFI, such as whether any data is present in the buffer of another LCH/LCG/QFI, whether the data volume in the buffer of another LCH/LCG/QFI higher/lower than a threshold, whether the delay-critical data volume in the buffer of another LCH/LCG/QFI higher/lower than a threshold, whether another LCH/LCG/QFI has already triggered the delay-aware mode, whether any important PDU Set is in the buffer of another LCH/LCG/QFI, or any combinations thereof.

In some embodiments, an LCH/LCG/QFI may directly trigger the delay-aware LCP mode as soon as another LCH/LCG/QFI triggers the delay-aware LCP mode, without consideration of remaining time.

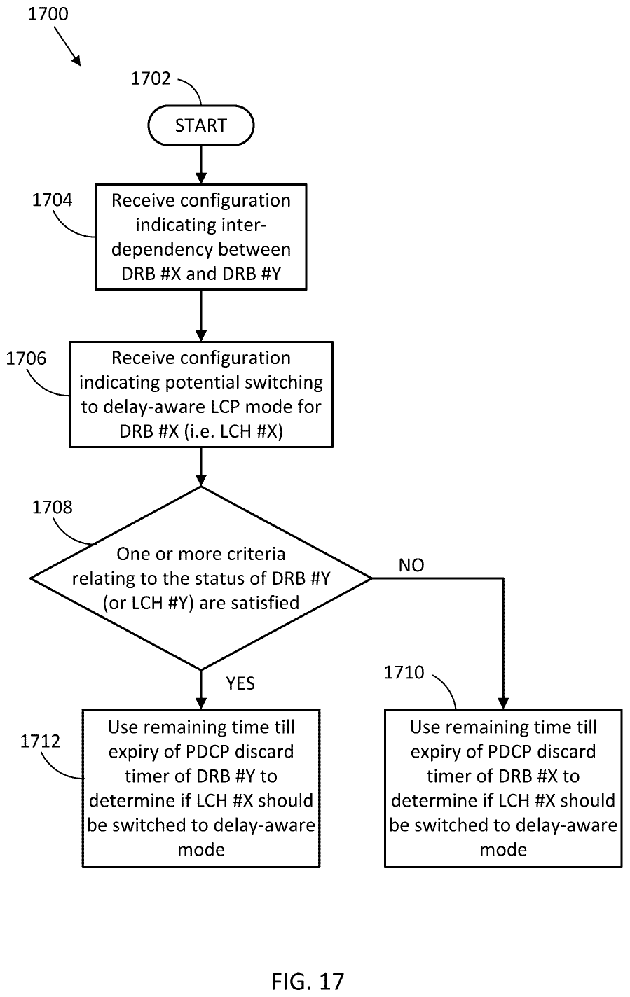

FIG. 17 illustrates an example triggering condition of delay-aware LCP procedure 1700 in accordance with some embodiments. The procedure 1700 may illustrate an example approach for determining when an LCH is to be switched to delay-aware mode. For example, the procedure 1700 may be performed by a device for determining when to switch LCH #X to delay-aware mode. The procedure 1700 may be performed with LCG and/or QFI in other embodiments.

The procedure 1700 may start at 1702. The procedure 1700 may include the device performing the procedure 1700 receiving a configuration indicating inter-dependency between DRB #X and DRB #Y in 1704. For example, the configuration may indicate that the first data in DRB #X is inter-dependent with the second data in DRB #Y. The device may determine that the first data and the second data are inter-dependent, and that the first data and the second data are to be synchronized based on the configuration.

The procedure 1700 may include receiving configuration indicating potential switching to delay-aware LCP mode for DRB #X (or LCH #X) in 1706. For example, the device may receive a configuration to apply the first triggering condition, the second triggering condition, or both.

The procedure 1700 may include determining whether one or more criteria relating to the status of DRB #Y (or LCH #Y) are satisfied in 1708. For example, the device may determine whether any data is present in the buffer of the DRB #Y (or LCH #Y), whether the data volume in the buffer of the DRB #Y (or LCH #Y) is higher/lower than a threshold, whether the delay-critical data volume in the buffer of the DRB #Y (or LCH #Y) is higher/lower than a threshold, whether the DRB #Y (or LCH #Y) has already triggered the delay-aware mode, whether any important PDU set in in the buffer of the DRB #Y (or LCH #Y), or some combination thereof.

If the one or more criteria are determined not to be satisfied in 1708, the procedure may proceed to 1710. The procedure 1700 may include using remaining time till expiry of PDCP discard timer of DRB #X to determine if LCH #X should be switched to delay-aware mode in 1710.

If the one or more criteria are determined to be satisfied in in 1708, the procedure may proceed to 1712. The procedure 1700 may include using remaining time till expiry of PDCP discard timer of DRB #Y to determine if LCH #X should be switched to delay-aware mode in 1712.

A sixth approach (which may be referred to as “approach 6”) may relate to complementary signallings. In any of the proposed approaches, the network may signal the dynamic commands to activate or deactivate the proposed UE behavior (e.g., via PDCP Control PDU, MAC CE, or downlink control information (DCI)). In any of the proposed approaches, the UE may signal the dynamic notifications to inform the network (NW) whether the proposed UE behavior has been applied (e.g., via PDCP Control PDU, MAC CE, or UCI). The UE may send UE Assistance Information (UAI) via the radio resource control message (RRC) message to notify the NW which traffic flows are interdependent (i.e., synchronization is needed among these traffic flows).

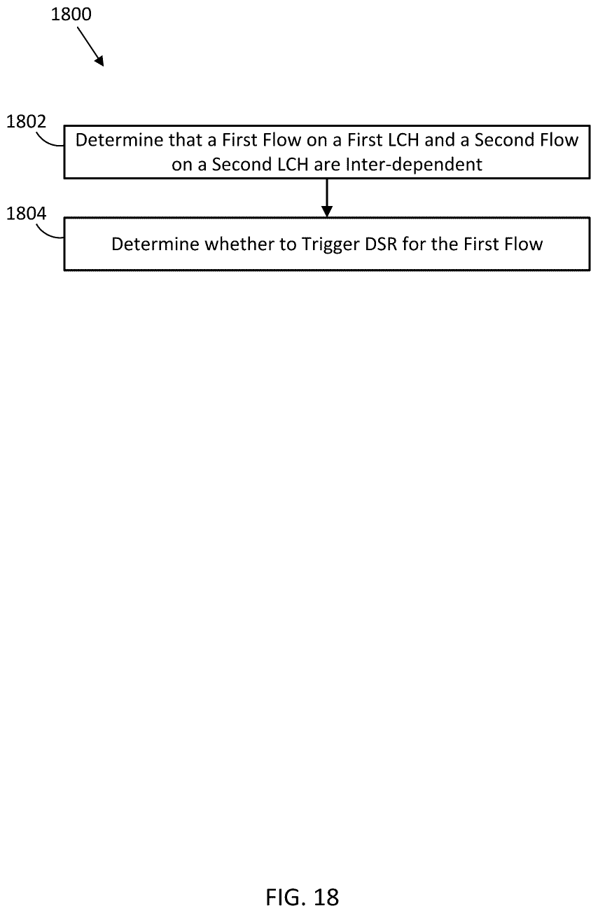

FIG. 18 illustrates an example procedure 1800 for determining whether to trigger DSR in accordance with some embodiments. The procedure 1800 may be performed by a UE, such as the UE 104 (FIG. 1), the UE 106 (FIG. 1), the UE 200 (FIG. 2).

The procedure 1800 may include determining that a first flow on a first LCH and a second flow on a second LCH are inter-dependent in 1802. In some embodiments, determining that the first flow and the second flow are inter-dependent may include determining that the first flow and the second flow belong to a same modality-group.

The procedure 1800 may include determining whether to trigger DSR for the first flow in 1804. For example, the UE may determine whether to trigger DSR for the first flow based at least in part on whether a condition is met relating to the second flow.

In some embodiments, the condition may include date of the second flow becoming available in a buffer for transmission. In some of these embodiments, the procedure 1800 may further include determining that the data of the second flow has become available in the buffer. Determining whether to trigger the DSR may include determining to trigger the DSR based at least in part on the determination that the data of the second flow has become available in the buffer.

In some embodiments, the condition may include a remaining time for data buffered for the second flow satisfying a threshold. In some of these embodiments, the procedure 1800 may further include determining that the remaining time for the second flow has satisfied the threshold. Determining whether to trigger the DSR may include determining to trigger the DSR based at least in part on the remaining time for the data buffered for the second flow satisfying the threshold.

In some embodiments, the DSR may be a first DSR, and the condition may include a second DSR for the second flow being triggered. In some of these embodiments, the procedure 1800 may include determining that the second DSR for the second flow has been triggered. Determining whether to trigger the first DSR may include determining to trigger the first DSR for the first flow based at least in part on the determination that the second DSR for the second flow has been triggered.

In some embodiments, the condition may include a buffer delay difference between the first flow and the second flow satisfying a threshold. In some of these embodiments, the procedure 1800 may include determining that the buffer delay difference between the first flow and the second flow satisfies the threshold. Determining whether to trigger the DSR may include determining to trigger the DSR based at least in part on the determination that the buffer delay difference between the first flow and the second flow satisfies the threshold.

In some embodiments, the condition may include a synchronization threshold between two or modalities of the first flow or the second flow being less than a PDB or a PSDB. In some of these embodiments, the procedure 1800 may include determining that the synchronization threshold between the two or more modalities of the first flow or the second flow is less than the PDB or the PSDB. Determining whether to trigger the DSR may include determining to trigger the DSR based at least in part on the determination that the synchronization threshold between the two or more modalities of the first flow or the second flow is less than the PDB or the PSDB.

In some embodiments, the first flow may include a first DRB flow, a first LCH flow, or a first QoS flow. Further, the second flow may include a second DRB flow, a second LCH flow, or a second QoS flow.

Any one or more of the operations in FIG. 18 may be performed in a different order than shown and/or one or more of the operations may be performed concurrently in embodiments. Further, it should be understood that one or more of the operations may be omitted from and/or one or more additional operations may be added to the procedure 1800 in other embodiments.

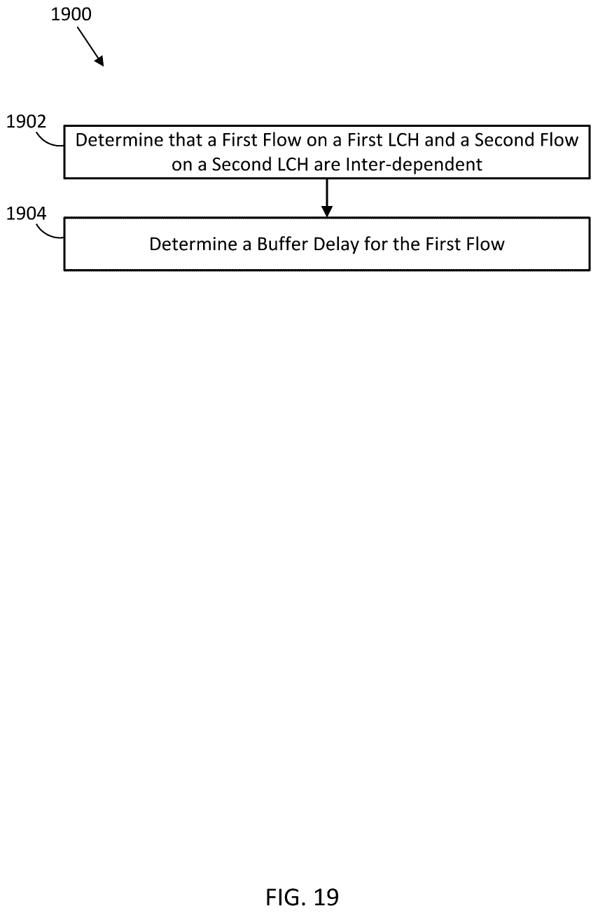

FIG. 19 illustrates an example procedure 1900 for determining a buffer delay for a first flow in accordance with some embodiments. The procedure 1900 may be performed by a UE, such as the UE 104 (FIG. 1), the UE 106 (FIG. 1), the UE 200 (FIG. 2).

The procedure 1900 may include determining that a first flow on a first LCH and a second flow on a second LCH are inter-dependent in 1902. In some embodiments, determining that the first flow and the second flow are inter-dependent may include determining that the first flow and the second flow belong to a same modality-group.

The procedure 1900 may include determining a buffer delay for the first flow in 1904. For example, the UE may determine a buffer delay for the first flow based at least in part on a discard timer for the second flow.

In some embodiments, the procedure 1900 may include determining a condition relating to a status of the second flow is met. The buffer delay for the first flow may be determined based at least in part on the discard timer for the second flow due to the condition being met. In some of these embodiments, the condition may include data of the second flow becoming available in a buffer for transmission, a remaining time for data buffered for the second flow satisfying a first threshold, DSR for the second flow being triggered, a buffer delay difference between the first flow and the second flow satisfying a second threshold, or a synchronization threshold between two or more modalities of the first flow or the second flow being less than a PDB or a PDSB.

In some embodiments, the first flow may include a first traffic flow, a first QoS flow, a first DRB flow, or a first LCH flow. The second flow may include a second traffic flow, a second QoS flow, a second DRB flow, or a second LCH flow.

Any one or more of the operations in FIG. 19 may be performed in a different order than shown and/or one or more of the operations may be performed concurrently in embodiments. Further, it should be understood that one or more of the operations may be omitted from and/or one or more additional operations may be added to the procedure 1900 in other embodiments.

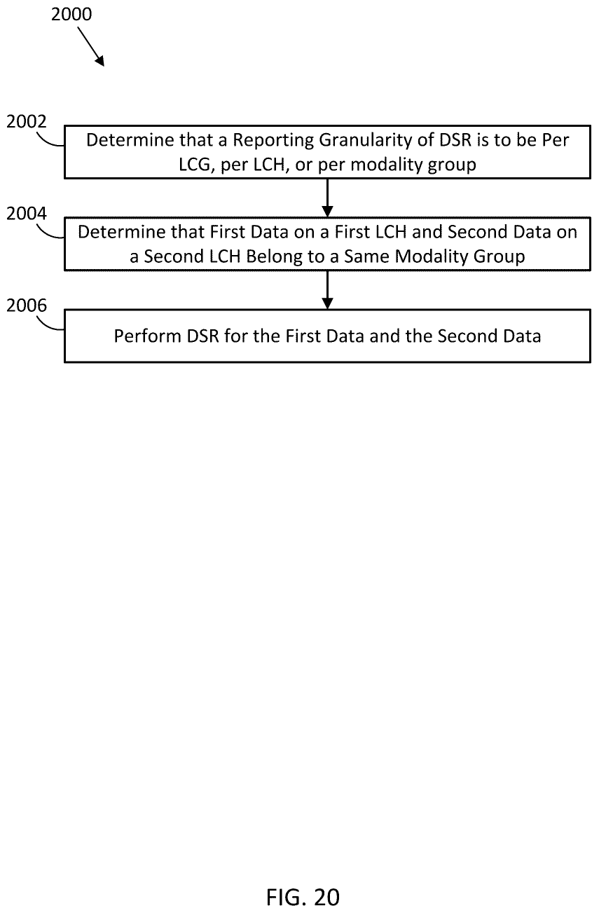

FIG. 20 illustrates an example procedure 2000 for performing DSR in accordance with a determined reporting granularity in accordance with some embodiments. The procedure 2000 may be performed by a UE, such as the UE 104 (FIG. 1), the UE 106 (FIG. 1), the UE 200 (FIG. 2).

The procedure 2000 may include determining that a reporting granularity of DSR is to be per LCG, per LCH, or per modality group in 2002. The UE may determine the reporting granularity based at least in part on a reporting granularity configuration of DSR.

The procedure 2000 may include determining that first data on a first LCH and second data on a second LCH belong to a same modality group in 2004. In some embodiments, the first data and the second data may be configured in different LCGs.

The procedure 2000 may include performing DSR for the first data and the second data in 2006. For example, the UE may perform DSR for the first data and the second data in accordance with the determined reporting granularity.

In some embodiments, performing the DSR for the first data and the second data may include generating a reporting message that includes one or more LCH IDs indicating to which one or more LCGs the DSR refers, one or more LCH IDs indicating to which one or more LCHs the DSR refers, one or more QOS IDs indicating to which one or more QoS flows the DSR refers, or one or more modality group IDs indicating to which one or more modality groups the DSR refers. In some of these embodiments, the reporting message may include the one or more LCG IDs based at least in part on the reporting granularity being per LCG. In some of these embodiments, the reporting message may include the one or more LCH IDs based at least in part on the reporting granularity being per LCH. In some of these embodiments, the reporting message may include the one or more modality group IDs based at least in part on the reporting granularity being per modality group. In some of these embodiments, a format of the reporting message may be based on whether the reporting granularity is per LCG, per LCH, or per modality group. In some of these embodiments, the reporting message may be a MAC CE message.

Any one or more of the operations in FIG. 20 may be performed in a different order than shown and/or one or more of the operations may be performed concurrently in embodiments. Further, it should be understood that one or more of the operations may be omitted from and/or one or more additional operations may be added to the procedure 2000 in other embodiments.

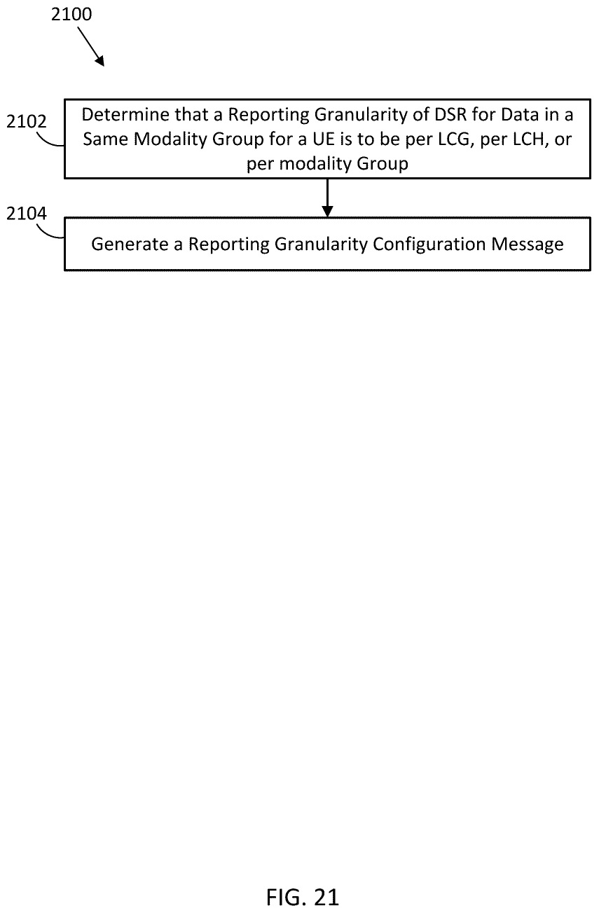

FIG. 21 illustrates an example procedure 2100 for generating a reporting granularity configuration message in accordance with some embodiments. The procedure 2100 may be performed by a base station, such as the base station 108 (FIG. 1), and/or the network device 300 (FIG. 3).

The procedure 2100 may include determining that a reporting granularity of DSR for data in a same modality group for a UE is to be per LCG, per LCH, or per modality group in 2102.

The procedure 2100 may include generating a reporting granularity configuration message in 2104. For example, the base station may generate a reporting granularity configuration message for transmission to the UE to indicate that the reporting granularity of DSR for data in the same modality group is to be per LCG, per LCH, or per modality group.

In some embodiments, the reporting granularity configuration message is to configure the UE to generate a reporting message for DSR. The reporting message may be to include one or more LCG IDs indicating to which one or more LCGs the DSR refers, one or more LCH IDs indicating to which one or more LCHs the DSR refers, one or more QoS IDs indicating to which one or more QoS flows the DSR refers, or one or more modality group IDs indicating to which one or more modality groups the DSR refers.

Any one or more of the operations in FIG. 21 may be performed in a different order than shown and/or one or more of the operations may be performed concurrently in embodiments. Further, it should be understood that one or more of the operations may be omitted from and/or one or more additional operations may be added to the procedure 2100 in other embodiments.

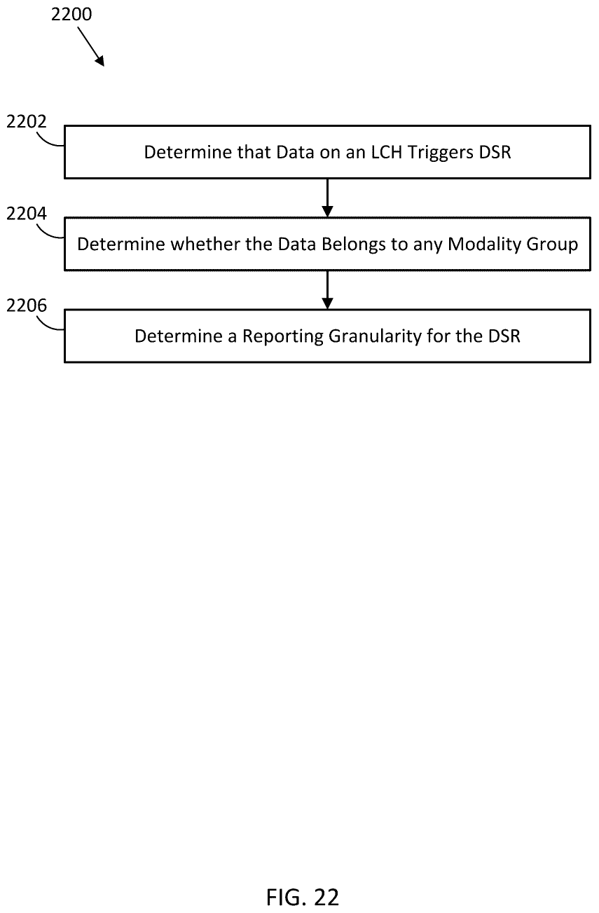

FIG. 22 illustrates an example procedure 2200 for determining a reporting granularity for DSR in accordance with some embodiments. The procedure 2200 may be performed by a UE, such as the UE 104 (FIG. 1), the UE 106 (FIG. 1), the UE 200 (FIG. 2).

The procedure 2200 may include determining that data on an LCH triggers DSR in 2202.

The procedure 2200 may include determining whether the data belongs to any modality group in 2204.

The procedure 2200 may include determining a reporting granularity for the DSR in 2206. For example, the UE may determine a reporting granularity for the DSR based at least in part on the determination whether the data belongs to any modality group.

In some embodiments, determining whether the data belongs to any modality group may include determining that the data does not belong to any modality group. Further, determining the reporting granularity may include determining to implement LCG-based reporting for the DSR based at least in part on the determination that the data does not belong to any modality group.

In some embodiments, determining whether the data belongs to any modality group may include determining that the data belongs to a modality group. Further, determining the reporting granularity may include determining to implement modality group-based reporting based at least in part on the determination that the data belongs to the modality group.

In some embodiments, the data may be first data. Determining whether the data belongs to any modality group may include determining that the first data belongs to a modality group. The procedure 2200 may further include determining that second data belonging to the modality group is not available in other LCHs. Determining the reporting granularity may include determining to implement LCG-based reporting for the DSR based at least in part on the determination that the second data is not available in other LCHs.

Any one or more of the operations in FIG. 22 may be performed in a different order than shown and/or one or more of the operations may be performed concurrently in embodiments. Further, it should be understood that one or more of the operations may be omitted from and/or one or more additional operations may be added to the procedure 2200 in other embodiments.

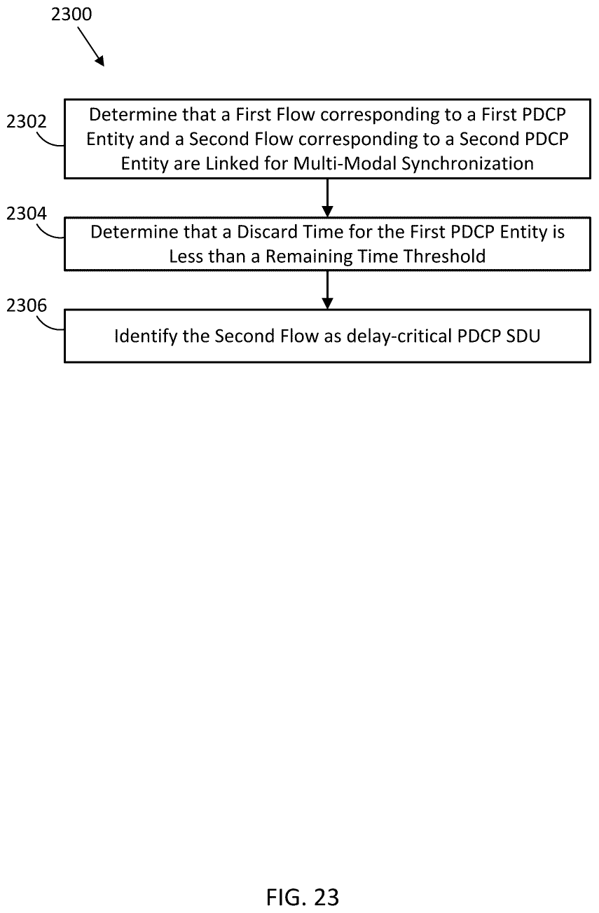

FIG. 23 illustrates an example procedure 2300 for identifying a flow as delay-critical PDCP SDU in accordance with some embodiments. The procedure 2300 may be performed by a UE, such as the UE 104 (FIG. 1), the UE 106 (FIG. 1), the UE 200 (FIG. 2).

The procedure 2300 may include determining that a first flow corresponding to a first PDCP entity and a second flow corresponding to a second PDCP entity are linked for multi-modal synchronization in 2302. In some embodiments, determining the first flow and the second flow are linked for multi-modal synchronization may include determining that the first PDCP entity and the second PDCP entity are inter-dependent based at least in part on a received configuration. In some embodiments, the first PDCP entity may be a first LCH, a first LCG, or a first RB. Further, the second PDCP entity may be a second LCH, a second LCG, or a second RB in some embodiments.

The procedure 2300 may include determining that a discard time for the first PDCP entity is less than a remaining time threshold in 2304.

The procedure 2300 may include identifying the second flow as delay-critical PDCP SDU in 2306. For example, the UE may identify the second flow as delay-critical PDCP SDU based at least in part on the determination that the discard time for the first PDCP entity is less than the remaining time threshold.

In some embodiments, the procedure 2300 may further include identifying the first flow as delay-critical PDCP SDU based at least in part on the determination that the discard time for the first PDCP entity is less than the remaining time threshold. In some embodiments, the second flow may be considered as delay-critical for DSR buffer size calculation based at least in part on the second flow being identified as delay-critical PDCP SDU.

In some embodiments, the procedure 2300 may further identify a configuration message received from a base station. The configuration message may configure for identifying flows as delay-critical PDCP SDUs based at least in part on PDCP entities with other flows that are linked for multi-modal synchronization having discard times less than the remaining time threshold. In some of these embodiments, the configuration message may include a PDCP control PDU message, a MAC CE message, or a DCI message.

In some embodiments, the procedure 2300 may further include generating a notification message for transmission to a base station. The notification message may indicate that flows with multi-modal synchronization with other flows on other PDCP entities with discard times less than the remaining time threshold are being identified as delay-critical PDCP SDUs. In some of these embodiments, the notification message may include a PDCP control PDU message, a MAC CE message, or a UCI message.

In some embodiments, the procedure 2300 may further include generating an RRC message for transmission to a base station. The RRC message may include user equipment assistance information (UAI) that indicates the first flow and the second flow are inter-dependent.

Any one or more of the operations in FIG. 23 may be performed in a different order than shown and/or one or more of the operations may be performed concurrently in embodiments. Further, it should be understood that one or more of the operations may be omitted from and/or one or more additional operations may be added to the procedure 2300 in other embodiments.

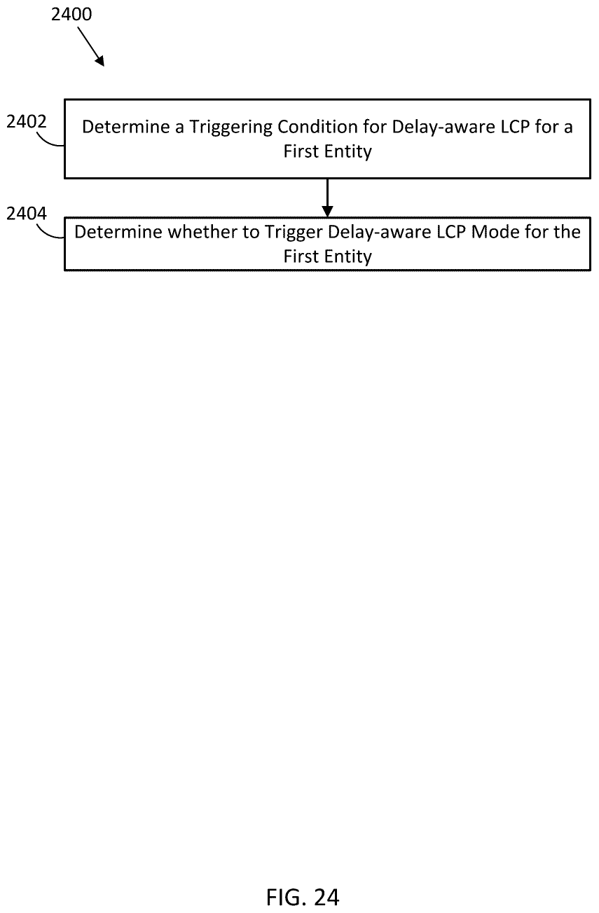

FIG. 24 illustrates an example procedure 2400 for determining whether to trigger delay-aware LCP mode for an entity in accordance with some embodiments. The procedure 2400 may be performed by a UE, such as the UE 104 (FIG. 1), the UE 106 (FIG. 1), the UE 200 (FIG. 2).

The procedure 2400 may include determining a triggering condition for delay-aware LCP for a first entity in 2402. For example, the UE may determine a triggering condition for delay-aware LCP for a first entity based at least in part on a status of a second entity. The first entity and the second entity may have multi-modal synchronization.

In some embodiments, determining the triggering condition may include determining the triggering condition based at least in part on whether any data is present in a buffer of the second entity, determining the triggering condition based at least in part on whether a data volume in a buffer of the second entity is higher than a first threshold, determining the triggering condition based at least in part on whether a data volume in a buffer of the second entity is lower than a second threshold, determining the triggering condition based at least in part on whether a delay-critical data volume in a buffer of the second entity is higher than a third threshold, determining the triggering condition based at least in part on whether a delay-critical data volume in a buffer of the second entity is lower than a fourth threshold, determining the triggering condition based at least in part on whether the second entity has triggered delay-aware LCP mode, or determining the triggering condition based at least in part on whether any important PDU set is in a buffer of the second entity.

In some embodiments, the first entity may be a first LCH, a first LCG or a first QFI. Further, the second entity may be a second LCH, a second LCG, or a second QFI.

The procedure 2400 may include determining whether to trigger delay-aware LCP mode for the first entity based at least in part on the determined triggering condition.

In some embodiments, the triggering condition may include a remaining time of a discard timer for the first entity satisfying a threshold. Determining whether to trigger delay-aware LCP mode for the first entity may include determining to trigger delay-aware LCP mode for the first entity based at least in part on the remaining time satisfying the threshold.

In some embodiments, the triggering condition may include a remaining time of a discard timer for the second entity satisfying a threshold. Determining whether to trigger delay-aware LCP mode for the first entity may include determining to trigger delay-aware LCP mode for the first entity based at least in part on the remaining time satisfying the threshold.

In some embodiments, the procedure 2400 may further include identifying a configuration message received from a base station. The configuration message may configure for determining the trigger condition based for delay-aware LCP for the first entity based at least in part on the status of the second entity. In some of these embodiments, the configuration message may include a PDCP control PDU message, a MAC CE message, or a DCI message.

In some embodiments, the procedure 2400 may further include generating a notification message for transmission to a base station. The notification message may indicate that the triggering condition for delay-aware LCP for the first entity is being determined based at least in part on the status of the second entity. In some embodiments, the notification message may include a PDCP control PDU message, a MAC CE message, or a UCI message.

In some embodiments, the procedure 2400 may further include generating a notification message for transmission to a base station. The notification message may indicate the triggering for condition for delay-aware LCP for the first entity. In some of these embodiments, the notification message may include a PDCP control PDU message, a MAC CE message, or a UCI message.

In some embodiments, the procedure 2400 may further include generating an RRC message for transmission to a base station. The RRC message may include UAI that indicates a first flow on the first entity and a second flow on the second entity are inter-dependent.

Any one or more of the operations in FIG. 24 may be performed in a different order than shown and/or one or more of the operations may be performed concurrently in embodiments. Further, it should be understood that one or more of the operations may be omitted from and/or one or more additional operations may be added to the procedure 2400 in other embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 may include a method comprising determining that a first flow on a first logical channel (LCH) and a second flow on a second LCH are inter-dependent, and determining whether to trigger delay status reporting for the first flow based at least in part on whether a condition is met relating to the second flow.

Example 2 may include the method of example 1, wherein the condition includes data of the second flow becoming available in a buffer for transmission.

Example 3 may include the method of example 2, further comprising determining that the data of the second flow has become available in the buffer, wherein determining whether to trigger the delay status reporting includes determining to trigger the delay status reporting based at least in part on the determination that the data of the second flow has become available in the buffer.

Example 4 may include the method of example 1, wherein the condition includes a remaining time for data buffered for the second flow satisfying a threshold.

Example 5 may include the method of example 4, further comprising determining that the remaining time for the second flow has satisfied the threshold, wherein determining whether to trigger the delay status reporting includes determining to trigger the delay status reporting based at least in part on the remaining time for the data buffered for the second flow satisfying the threshold.

Example 6 may include the method of example 1, wherein the delay status reporting is a first delay status reporting, and wherein the condition includes a second delay status reporting for the second flow being triggered.

Example 7 may include the method of example 6, further comprising determining that the second delay status reporting for the second flow has been triggered, wherein determining whether to trigger the first delay status reporting includes determining to trigger the first delay status reporting for the first flow based at least in part on the determination that the second delay status reporting for the second flow has been triggered.

Example 8 may include the method of example 1, wherein the condition includes a buffer delay difference between the first flow and the second flow satisfying a threshold.

Example 9 may include the method of example 8, further comprising determining that the buffer delay difference between the first flow and the second flow satisfies the threshold, wherein determining whether to trigger the delay status reporting includes determining to trigger the delay status reporting based at least in part on the determination that the buffer delay difference between the first flow and the second flow satisfies the threshold.

Example 10 may include the method of example 1, wherein the condition includes a synchronization threshold between two or more modalities of the first flow or the second flow being less than a packet delay budget (PDB) or a protocol data unit set delay budget (PSDB).

Example 11 may include the method of example 10, further comprising determining that the synchronization threshold between the two or more modalities of the first flow or the second flow is less than the PDB or the PSDB, wherein determining whether to trigger the delay status reporting includes determining to trigger the delay status reporting based at least in part on the determination that the synchronization threshold between the two or more modalities of the first flow or the second flow is less than the PDB or the PSDB.

Example 12 may include the method of example 1, wherein the first flow includes a first data radio bearer (DRB) flow, a first logical channel (LCH) flow, or a first quality of service (QOS) flow, and the second flow includes a second DRB flow, a second LCH flow, or a second QoS flow.

Example 13 may include the method of example 1, wherein determining that the first flow and the second flow are inter-dependent includes determining that the first flow and the second flow belong to a same modality-group.

Example 14 may include a method comprising determining that a first flow on a first logical channel (LCH) and a second flow on a second LCH are inter-dependent, and determining a buffer delay for the first flow based at least in part on a discard timer for the second flow.

Example 15 may include the method of example 14, further comprising determining a condition relating to a status of the second flow is met, wherein the buffer delay for the first flow is determined based at least in part on the discard timer for the second flow due to the condition being met.

Example 16 may include the method of example 15, wherein the condition includes data of the second flow becoming available in a buffer for transmission, a remaining time for data buffered for the second flow satisfying a first threshold, delay status reporting for the second flow being triggered, a buffer delay difference between the first flow and the second flow satisfying a second threshold, or a synchronization threshold between two or more modalities of the first flow or the second flow being less than a packet delay budget (PDB) or a protocol data unit set delay budget (PSDB).

Example 17 may include the method of example 14, wherein the first flow includes a first traffic flow, a first quality of service (QOS) flow, a first data radio bearer (DRB) flow, or a first LCH flow, and the second flow includes a second traffic flow, a second QoS flow, a second DRB flow, or a second LCH flow.

Example 18 may include the method of example 14, wherein determining that the first flow and the second flow are inter-dependent includes determining that the first flow and the second flow belong to a same modality-group.

Example 19 may include a method comprising determining, based at least in part on a reporting granularity configuration of delay status reporting, that a reporting granularity of delay status reporting is to be per logical channel group (LCG), per logical channel (LCH), or per modality group, determining that first data on a first LCH and second data on a second LCH belong to a same modality group, and performing delay status reporting for the first data and the second data in accordance with the determined reporting granularity.

Example 20 may include the method of example 19, wherein performing the delay status reporting for the first data and the second data includes generating a reporting message that includes one or more LCG identifiers (IDs) indicating to which one or more LCGs the delay status reporting refers, one or more LCH IDs indicating to which one or more LCHs the delay status reporting refers, one or more quality of service (QOS) IDs indicating to which one or more QoS flows the delay status reporting refers, or one or more modality group IDs indicting to which one or more modality groups the delay status reporting refers.

Example 21 may include the method of example 20, wherein the reporting message includes the one or more LCG IDs based at least in part on the reporting granularity being per LCG.

Example 22 may include the method of example 20, wherein the reporting message includes the one or more LCH IDs based at least in part on the reporting granularity being per LCH.

Example 23 may include the method of example 20, wherein the reporting message includes the one or more modality group IDs based at least in part on the reporting granularity being per modality group.

Example 24 may include the method of example 20, wherein a format of the reporting message is based on whether the reporting granularity is per LCG, per LCH, or per modality group.

Example 25 may include the method of example 20, wherein the reporting message is a medium access control (MAC) control element (CE) message.

Example 26 may include the method of example 19, wherein the first data and the second data are configured in different LCGs.

Example 27 may include a method comprising determining that a reporting granularity of delay status reporting for data in a same modality group for a user equipment (UE) is to be per logical channel group (LCG), per logical channel (LCH), or per modality group, and generating a reporting granularity configuration message for transmission to the UE to indicate that the reporting granularity of delay status reporting for data in the same modality group is to be per LCG, per LCH, or per modality group.

Example 28 may include the method of example 27, wherein the reporting granularity configuration message is to configure the UE to generate a reporting message for delay status reporting, wherein reporting message is to include one or more LCG identifiers (IDs) indicating to which one or more LCGs the delay status reporting refers, one or more LCH IDs indicating to which one or more LCHs the delay status reporting refers, one or more quality of service (QOS) IDs indicating to which one or more QoS flows the delay status reporting refers, or one or more modality group IDs indicting to which one or more modality groups the delay status reporting refers.

Example 29 may include a method comprising determining that data on a logical channel (LCH) triggers delay status reporting, determining whether the data belongs to any modality group, and determining a reporting granularity for the delay status reporting based at least in part on the determination whether the data belongs to any modality group.

Example 30 may include the method of example 29, wherein determining whether the data belongs to any modality group includes determining that the data does not belong to any modality group, and wherein determining the reporting granularity includes determining to implement logical channel group (LCG)-based reporting for the delay status reporting based at least in part on the determination that the data does not belong to any modality group.

Example 31 may include the method of example 29, wherein determining whether the data belongs to any modality group includes determining that the data belongs to a modality group, and wherein determining the reporting granularity includes determining to implement modality group-based reporting based at least in part on the determination that the data belongs to the modality group.

Example 32 may include the method of example 29, wherein the data is first data, wherein determining whether the data belongs to any modality group includes determining that the first data belongs to a modality group, wherein the method further comprises determining that second data belonging to the modality group is not available in other LCHs, and wherein determining the reporting granularity includes determining to implement logical channel group (LCG)-based reporting for the delay status reporting based at least in part on the determination that the second data is not available in other LCHs.

Example 33 may include a method comprising determining that a first flow corresponding to a first packet data convergence protocol (PDCP) entity and a second flow corresponding to a second PDCP entity are linked for multi-modal synchronization, determining that a discard time for the first PDCP entity is less than a remaining time threshold, and identifying the second flow as delay-critical PDCP service data unit (SDU) based at least in part on the determination that the discard time for the first PDCP entity is less than the remaining time threshold.

Example 34 may include the method of example 33, further comprising identifying the first flow as delay-critical PDCP SDU based at least in part on the determination that the discard time for the first PDCP entity is less than the remaining time threshold.

Example 35 may include the method of example 33, wherein determining the first flow and the second flow are linked for multi-modal synchronization comprises determining that the first PDCP entity and the second PDCP entity are inter-dependent based at least in part on a received configuration.

Example 36 may include the method of example 33, wherein the second flow is considered as delay-critical for delay status reporting buffer size calculation based at least in part on the second flow being identified as delay-critical PDCP SDU.

Example 37 may include the method of example 33, wherein the first PDCP entity is a first logical channel (LCH), a first logical channel group (LCG), or a first radio bearer (RB), and the second PDCP entity is a second LCH, a second LCG, or a second RB.

Example 38 may include the method of example 33, further comprising identifying a configuration message received from a base station, wherein the configuration message configures for identifying flows as delay-critical PDCP SDUs based at least in part on PDCP entities with other flows that are linked for multi-modal synchronization having discard times less than the remaining time threshold.

Example 39 may include the method of example 38, wherein the configuration message includes a PDCP control packet data unit (PDU) message, a medium access control (MAC) control element (CE) message, or a downlink control information (DCI) message.

Example 40 may include the method of example 33, further comprising generating a notification message for transmission to a base station, wherein the notification message indicates that flows with multi-modal synchronization with other flows on other PDCP entities with discard times less than the remaining time threshold are being identified as delay-critical PDCP SDUs.

Example 41 may include the method of example 40, wherein the notification message includes a PDCP control packet data unit (PDU) message, a medium access control (MAC) control element (CE) message, or an uplink control information (UCI) message.

Example 42 may include the method of example 33, further comprising generating a radio resource control (RRC) message for transmission to a base station, the RRC message including user equipment assistance information (UAI) that indicates the first flow and the second flow are inter-dependent.

Example 43 may include a method comprising determining a triggering condition for delay-aware logical channel prioritization (LCP) for a first entity based at least in part on a status of a second entity, the first entity and the second entity having multi-modal synchronization, and determining whether to trigger delay-aware LCP mode for the first entity based at least in part on the determined triggering condition.

Example 44 may include the method of example 43, wherein determining the triggering condition includes determining the triggering condition based at least in part on whether any data is present in a buffer of the second entity, determining the triggering condition based at least in part on whether a data volume in a buffer of the second entity is higher than a first threshold, determining the triggering condition based at least in part on whether a data volume in a buffer of the second entity is lower than a second threshold, determining the triggering condition based at least in part on whether a delay-critical data volume in a buffer of the second entity is higher than a third threshold, determining the triggering condition based at least in part on whether a delay-critical data volume in a buffer of the second entity is lower than a fourth threshold, determining the triggering condition based at least in part on whether the second entity has triggered delay-aware LCP mode, or determining the triggering condition based at least in part on whether any important packet data unit (PDU) set is in a buffer of the second entity.

Example 45 may include the method of example 43, wherein the triggering condition includes a remaining time of a discard timer for the first entity satisfying a threshold, and wherein determining whether to trigger delay-aware LCP mode for the first entity includes determining to trigger delay-aware LCP mode for the first entity based at least in part on the remaining time satisfying the threshold.

Example 46 may include the method of example 43, wherein the triggering condition includes a remaining time of a discard timer for the second entity satisfying a threshold, and wherein determining whether to trigger delay-aware LCP mode for the first entity includes determining to trigger delay-aware LCP mode for the first entity based at least in part on the remaining time satisfying the threshold.

Example 47 may include the method of example 43, wherein the first entity is a first logical channel (LCH), a first logical channel group (LCG), or a first quality of service flow identifier (QFI), and the second entity is a second LCH, a second LCG, or a second QFI.

Example 48 may include the method of example 43, further comprising identifying a configuration message received from a base station, wherein the configuration message configures for determining the trigger condition based for delay-aware LCP for the first entity based at least in part on the status of the second entity.

Example 49 may include the method of example 48, wherein the configuration message includes a PDCP control packet data unit (PDU) message, a medium access control (MAC) control element (CE) message, or a downlink control information (DCI) message.

Example 50 may include the method of example 43, further comprising generating a notification message for transmission to a base station, wherein the notification message indicates that the triggering condition for delay-aware LCP for the first entity is being determined based at least in part on the status of the second entity.

Example 51 may include the method of example 50, wherein the notification message includes a PDCP control packet data unit (PDU) message, a medium access control (MAC) control element (CE) message, or an uplink control information (UCI) message.

Example 52 may include the method of example 43, further comprising generating a notification message for transmission to a base station, wherein the notification message indicates the triggering condition for delay-aware LCP for the first entity.

Example 53 may include the method of example 52, wherein the notification message includes a PDCP control packet data unit (PDU) message, a medium access control (MAC) control element (CE) message, or an uplink control information (UCI) message.

Example 54 may include the method of example 43, further comprising generating a radio resource control (RRC) message for transmission to a base station, the RRC message including user equipment assistance information (UAI) that indicates a first flow on the first entity and a second flow on the second entity are inter-dependent.

Example 55 may include an apparatus comprising means to perform one or more elements of a method described in or related to any of examples 1-54, or any other method or process described herein.

Example 56 may include one or more non-transitory computer-readable media comprising instructions to cause an electronic device, upon execution of the instructions by one or more processors of the electronic device, to perform one or more elements of a method described in or related to any of examples 1-54, or any other method or process described herein.

Example 57 may include an apparatus comprising logic, modules, or circuitry to perform one or more elements of a method described in or related to any of examples 1-54, or any other method or process described herein.

Example 58 may include a method, technique, or process as described in or related to any of examples 1-54, or portions or parts thereof.

Example 59 may include an apparatus comprising: one or more processors and one or more computer-readable media comprising instructions that, when executed by the one or more processors, cause the one or more processors to perform the method, techniques, or process as described in or related to any of examples 1-54, or portions thereof.

Example 60 may include a signal as described in or related to any of examples 1-54, or portions or parts thereof.

Example 61 may include a datagram, information element, packet, frame, segment, PDU, or message as described in or related to any of examples 1-54, or portions or parts thereof, or otherwise described in the present disclosure.

Example 62 may include a signal encoded with data as described in or related to any of examples 1-54, or portions or parts thereof, or otherwise described in the present disclosure.

Example 63 may include a signal encoded with a datagram, IE, packet, frame, segment, PDU, or message as described in or related to any of examples 1-54, or portions or parts thereof, or otherwise described in the present disclosure.

Example 64 may include an electromagnetic signal carrying computer-readable instructions, wherein execution of the computer-readable instructions by one or more processors is to cause the one or more processors to perform the method, techniques, or process as described in or related to any of examples 1-54, or portions thereof.

Example 65 may include a computer program comprising instructions, wherein execution of the program by a processing element is to cause the processing element to carry out the method, techniques, or process as described in or related to any of examples 1-54, or portions thereof.

Example 66 may include a signal in a wireless network as shown and described herein.

Example 67 may include a method of communicating in a wireless network as shown and described herein.

Example 68 may include a system for providing wireless communication as shown and described herein.

Example 69 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. One or more non-transitory, computer-readable media having instructions that, when executed, cause processing circuitry to:
determine that a first flow on a first logical channel (LCH) and a second flow on a second LCH are inter-dependent; and
generate a delay status report for the first flow based at least in part on a condition being met relating to the second flow.

2. The one or more non-transitory, computer-readable media of claim 1, wherein the condition includes data of the second flow becoming available in a buffer for transmission.

3. The one or more non-transitory, computer-readable media of claim 2, wherein the instructions, when executed, further cause the processing circuitry to:
determine that the data of the second flow has become available in the buffer, wherein to generate the delay status report includes to generate the delay status report based at least in part on the determination that the data of the second flow has become available in the buffer.

4. The one or more non-transitory, computer-readable media of claim 1, wherein the condition includes a remaining time for data buffered for the second flow satisfying a threshold.

5. The one or more non-transitory, computer-readable media of claim 4, wherein the instructions, when executed, further cause the processing circuitry to:
determine that the remaining time for the second flow has satisfied the threshold, wherein to generate the delay status report includes to generate the delay status report based at least in part on the remaining time for the data buffered for the second flow satisfying the threshold.

6. The one or more non-transitory, computer-readable media of claim 1, wherein the delay status report is a first delay status report, and wherein the condition includes a second delay status report for the second flow being triggered.

7. The one or more non-transitory, computer-readable media of claim 1, wherein the condition includes a buffer delay difference between the first flow and the second flow satisfying a threshold.

8. The one or more non-transitory, computer-readable media of claim 1, wherein the condition includes a synchronization threshold between two or more modalities of the first flow or the second flow being less than a packet delay budget (PDB) or a protocol data unit set delay budget (PSDB).

9. The one or more non-transitory, computer-readable media of claim 1, wherein:
the first flow includes a first data radio bearer (DRB) flow, a first logical channel (LCH) flow, or a first quality of service (QOS) flow; and
the second flow includes a second DRB flow, a second LCH flow, or a second QoS flow.

10. The one or more non-transitory, computer-readable media of claim 1, wherein to determine that the first flow and the second flow are inter-dependent includes to determine that the first flow and the second flow belong to a same modality-group.

11. An apparatus comprising:
processing circuitry to:
determine, based at least in part on a reporting granularity configuration of delay status reporting, that a reporting granularity of delay status reporting is to be per logical channel group (LCG), per logical channel (LCH), or per modality group;
determine that first data on a first LCH and second data on a second LCH belong to a same modality group; and
perform delay status reporting for the first data and the second data in accordance with the reporting granularity; and
interface circuitry coupled with the processing circuitry, the interface circuitry to enable communication.

12. The apparatus of claim 11, wherein to perform the delay status reporting for the first data and the second data includes to generate a reporting message that includes:
one or more LCG identifiers (IDs) indicating to which one or more LCGs the delay status reporting refers;
one or more LCH IDs indicating to which one or more LCHs the delay status reporting refers;
one or more quality of service (QOS) IDs indicating to which one or more QoS flows the delay status reporting refers; or
one or more modality group IDs indicting to which one or more modality groups the delay status reporting refers.

13. The apparatus of claim 12, wherein the reporting message includes the one or more LCG IDs based at least in part on the reporting granularity being per LCG.

14. The apparatus of claim 12, wherein the reporting message includes the one or more LCH IDs based at least in part on the reporting granularity being per LCH.

15. The apparatus of claim 12, wherein the reporting message includes the one or more modality group IDs based at least in part on the reporting granularity being per modality group.

16. The apparatus of claim 12, wherein a format of the reporting message is based on whether the reporting granularity is per LCG, per LCH, or per modality group.

17. The apparatus of claim 12, wherein the reporting message is a medium access control (MAC) control element (CE) message.

18. The apparatus of claim 11, wherein the first data and the second data are configured in different LCGs.

19. A method comprising:
determining that a reporting granularity of delay status reporting for data in a same modality group for a user equipment (UE) is to be per logical channel group (LCG), per logical channel (LCH), or per modality group; and
generating a reporting granularity configuration message for transmission to the UE to indicate that the reporting granularity of delay status reporting for data in the same modality group is to be per LCG, per LCH, or per modality group.

20. The method of claim 19, wherein the reporting granularity configuration message is to configure the UE to generate a reporting message for delay status reporting, wherein reporting message is to include:
one or more LCG identifiers (IDs) indicating to which one or more LCGs the delay status reporting refers;
one or more LCH IDs indicating to which one or more LCHs the delay status reporting refers;
one or more quality of service (QOS) IDs indicating to which one or more QoS flows the delay status reporting refers; or
one or more modality group IDs indicting to which one or more modality groups the delay status reporting refers.
